(19) United States
(12) Patent Application Publication
(10) Pub. No.: US 2016/0364547 A1
(43) Pub. Date: Dec. 15, 2016

(54) SYSTEM AND METHOD FOR PROVIDING HOSPITAL PATIENTS WITH RETAIL PHARMACY SERVICES

(71) Applicant: Meijer, Inc., Grand Rapids, MI (US)

(72) Inventors: Nathaniel J. Love, Grand Rapids, MI (US); Harold Brent Hubble, Ada, MI (US); David Scott Pallas, Hudsonville, MI (US)

(21) Appl. No.: 15/179,750

(22) Filed: Jun. 10, 2016

Related U.S. Application Data
(60) Provisional application No. 62/173,938, filed on Jun. 11, 2015.

(51) Int. Cl. G06F 19/00

(52) U.S. Cl. CPC G06F 19/3456; G06F 19/3418

(57) ABSTRACT

In a system and method for filling post-discharge medications of a hospital patient a first receive signal carries a consent indicator indicating consent by the hospital patient or a caregiver of the hospital patient to fill at least one post-discharge medication prescribed or to be prescribed to the hospital patient, a second received signal carries an identifier of one of a plurality of affiliated retail pharmacies at which to fill the at least one post-discharge medication, the consent indicator is transmitted to a Pharmacy Benefit Management (PBM) service used by a physician of the hospital patient to process the at least one post-discharge medical prescription prescribed thereby in order to gain access to the at least one medical prescription prescribed by the patient's physician, the at least one medical prescription from the PBM service is received based on the consent indicator, and the obtained at least one medical prescription is transmitted to the identified one of the plurality of retail pharmacies with instructions to fill the at least one medical prescription.

### CROSS-REFERENCE TO RELATED APPLICATION

This application claims the benefit of, and priority to, U.S. Patent Application No. 62/173,938, filed Jun. 11, 2015, the disclosure of which is incorporated herein by reference in its entirety.

### FIELD OF THE INVENTION

The present invention relates generally to systems and methods for providing hospital patients with retail pharmacy services, and more specifically to such systems and methods for providing such patients with retail pharmacy services via a retail pharmacy co-located with the hospital in which the patient is currently resident and/or via another retail pharmacy of the patient's choosing.

### BACKGROUND

Retail pharmacies can typically be found near hospital locations in order to serve the needs of discharged hospital patients. It may be desirable to locate a retail pharmacy within or connected to a hospital for the convenience of hospital patients, caregivers, hospital employees and visitors. It may further be desirable to provide systems and methods for providing various retail pharmacy services to hospital patients regardless of whether the retail pharmacy is co-located at the hospital and/or located nearby.

### SUMMARY

The present invention may comprise one or more of the features recited in the attached claims, and/or one or more of the following features and combinations thereof. In one aspect, a method of filling post-discharge medications of a hospital patient may comprise receiving via communication circuitry of a retail pharmacy server a first signal carrying a consent indicator indicating consent by the hospital patient or a caregiver of the hospital patient to fill at least one post-discharge medication prescribed or to be prescribed to the hospital patient, receiving via the communication circuitry of the retail pharmacy server a second signal carrying an identifier of one of a plurality of retail pharmacies affiliated with the retail pharmacy server at which to fill the at least one post-discharge medication, transmitting with the communication circuitry of the retail pharmacy server the consent indicator to a Pharmacy Benefit Management (PBM) service used by a physician of the hospital patient to process the at least one post-discharge medical prescription prescribed thereby in order to gain access to the at least one medical prescription prescribed by the patient's physician, receiving with the communication circuitry of the retail pharmacy server the at least one medical prescription from the PBM service based on the consent indicator, and transmitting with the communication circuitry of the retail pharmacy server the obtained at least one medical prescription to the identified one of the plurality of retail pharmacies with instructions to fill the at least one medical prescription.

In another aspect, a system for filling post-discharge medications of a hospital patient may comprise a retail pharmacy server communicatively coupled to a plurality of affiliated retail pharmacies, the retail pharmacy server including at least one processor, communication circuitry coupled to the retail pharmacy server, and a memory having instructions stored therein that are executable by the at least one processor to receive via the communication circuitry a first signal carrying a consent indicator indicating consent by the hospital patient or a caregiver of the hospital patient to fill at least one post-discharge medication prescribed or to be prescribed to the hospital patient, to receive via the communication circuitry a second signal carrying an identifier of one of the plurality of affiliated retail pharmacies at which to fill the at least one post-discharge medication, to transmit with the communication circuitry the consent indicator to a Pharmacy Benefit Management (PBM) service used by a physician of the hospital patient to process the at least one post-discharge medical prescription prescribed thereby in order to gain access to the at least one medical prescription prescribed by the patient's physician, to receive with the communication circuitry the at least one medical prescription from the PBM service based on the consent indicator, and to transmit with the communication circuitry the obtained at least one medical prescription to the identified one of the plurality of affiliated retail pharmacies with instructions to fill the at least one medical prescription.

The hospital patient is illustratively admitted to a hospital. The identified one of the plurality of affiliated retail pharmacies may be co-located at the hospital at which the patient is admitted.

In yet another aspect, a computer implemented method for making a product recommendation to a communication device of a patient following discharge of the patient from a hospital as part of a hospital stay may comprise causing, with a first processor carried by of a pharmacy server, communication circuitry of the pharmacy server to transmit to a hospital server a request for patient information relating to the patient's hospital stay, receiving, with the first processor, the requested patient information from the hospital server, determining, based on the requested patient information, at least one of a product to recommend to the patient, a product to be avoided by the patient and a product to substitute for a product previously or typically purchased by the patient, and causing, with the first processor, the communication circuitry of the pharmacy server to transmit to the communication device of the patient at least one of the product to recommend to the patient, the product to be avoided by the patient and the product to substitute for a product previously or typically purchased by the patient. The method may further comprise receiving, with a second processor carried by the communication device of the patient, the transmitted at least one of the product to recommend to the patient, the product to be avoided by the patient and the product to substitute for a product previously or typically purchased by the patient, and causing, by the second processor, a display carried by the communication device to display thereon the at least one of the product to recommend to the patient, the product to be avoided by the patient and the product to substitute for a product previously or typically purchased by the patient.

In still a further aspect, a computer implemented method for establishing a live communication link between a first communication device of a patient following discharge of the patient from a hospital as part of a hospital stay and a second communication device of one of a plurality of pharmacists of a retail pharmacy may comprise receiving by a first processor of a pharmacy server a transmitted request for the live communication link and an identification of the patient, determining, by the first processor, an identity of the patient by matching the received identification of the patient with patient information stored in a database of the pharmacy server, retrieving, by the first processor from the database, patient information relating to the patient's hospital stay, retrieving, by the first processor from the database, pharmacist information for the plurality of pharmacists of the retail pharmacy, selecting one or more of the plurality of pharmacists by matching at least some of the patient information relating to the patient's hospital stay with one or more attributes of the pharmacist information, transmitting, under control of the first processor, a patient communication link to the first communication device of the patient, and transmitting, under control of the first processor, a pharmacist communication link to at least one communication device associated with each of the one or more selected pharmacists, wherein the first communication device and the at least one communication device associated with one of the one or more selected pharmacists establish live communication via the patient communication link and the pharmacist communication link.

### BRIEF DESCRIPTION OF THE DRAWINGS

This disclosure is illustrated by way of example and not by way of limitation in the accompanying figures. Where considered appropriate, reference labels have been repeated among the figures to indicate corresponding or analogous elements.

FIG. 1 is a simplified block diagram of an embodiment of a system for providing hospital patients with pharmacy services.

FIG. 2A is a simplified block diagram of an embodiment of one of the mobile communication devices illustrated in FIG. 1.

FIG. 2B is a simplified block diagram of an embodiment of one of the caregiver computers illustrated in FIG. 1.

FIG. 3 is a simplified block diagram of an embodiment of a software environment of the pharmacy server of FIG. 1.

FIG. 4 is a simplified flow diagram of an embodiment of a pharmacy services process operable to recognize a mobile communication device upon entry to the hospital and to execute various pharmacy service processes.

FIG. 5A is a simplified flow diagram of an embodiment of a hospital stay mode or application executed as part of the process illustrated in FIG. 4.

FIG. 5B is a simplified flow diagram of an embodiment of a patient discharge status determination process executed as part of the process illustrated in FIG. 5A.

FIG. 6 is a simplified flow diagram of an embodiment of a maps process executed as part of the process illustrated in FIG. 5A.

FIGS. 7A and 7B illustrate a simplified flow diagram of an embodiment of a schedule discharge medications process executed as part of the process illustrated in FIG. 5A.

FIG. 7C is a simplified flow diagram of an embodiment of a pharmacy consult process executed as part of the process illustrated in FIGS. 7A and 7B.

FIG. 8 is a simplified flow diagram of an embodiment of a scan insurance card process executed as part of the process illustrated in FIG. 5A.

FIG. 9 is a simplified flow diagram of an embodiment of a diagnosis information process executed as part of the process illustrated in FIG. 5A.

FIG. 10 is a simplified flow diagram of an embodiment of a hospital stay-based product recommendation, avoidance and/or substitution process executed as part of the process illustrated in FIG. 5A.

FIG. 11 is a simplified flow diagram of an embodiment of a pharmacist inquiry process executed as part of the process illustrated in FIG. 5A.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases may or may not necessarily refer to the same embodiment. Further, when a particular feature, structure, process, process step or characteristic is described in connection with an embodiment, it is submitted that it is within the knowledge of one skilled in the art to effect such feature, structure, process, process step or characteristic in connection with other embodiments whether or not explicitly described. Further still, it is contemplated that any single feature, structure, process, process step or characteristic disclosed herein may be combined with any one or more other disclosed feature, structure, process, process step or characteristic, whether or not explicitly described, and that no limitations on the types and/or number of such combinations should therefore be inferred.

Embodiments of the invention may be implemented in hardware, firmware, software, or any combination thereof. Embodiments of the invention implemented in a computer system may include one or more bus-based interconnects between components and/or one or more point-to-point interconnects between components. Embodiments of the invention may also be implemented as instructions stored on one or more machine-readable media, which may be read and executed by one or more processors. A machine-readable medium may be embodied as any device or physical structure for storing or transmitting information in a form readable by a machine (e.g., a computing device). For example, a machine-readable medium may be embodied as any one or combination of read only memory (ROM); random access memory (RAM); magnetic disk storage media; optical storage media; flash memory devices; and others.

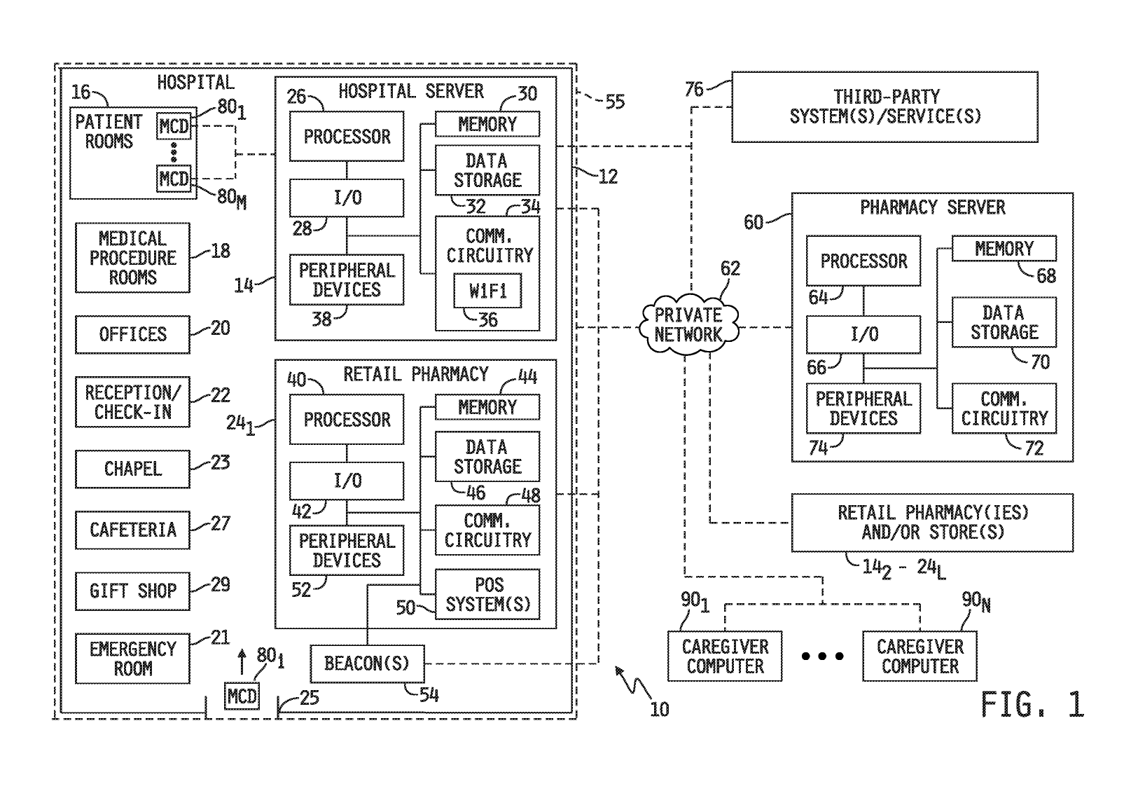

Referring now to FIG. 1, a system 10 is shown for providing hospital patients with pharmacy services. The system 10 illustratively includes a hospital 12 with a retail pharmacy 24₁ located within or attached thereto such that the retail pharmacy 24₁ is co-located with the hospital 12 and is accessible from within the hospital 12. The hospital 12 is otherwise conventional and includes a hospital server 14 operable to manage, at least in part, business, financial and medical operations of the hospital 12, a plurality of patient rooms 16, a plurality of medical procedure rooms 18, a plurality of administrative and professional offices 20, an emergency room (ER) 21, a reception and/or patient check-in area 22, a chapel 23, at least one cafeteria 27 or other food/beverage service area, a gift shop 29 and at least one entrance 25 to/from the hospital. The hospital server 14 is illustratively communicatively coupled to one or more third-party systems 76 which provide one or more third-party services to the hospital 12 and/or to the physicians employed by or otherwise having privileges at the hospital 12. Examples of third-party systems/services 76 include, but are not limited to, one or more medical insurance company systems/services, one or more external medical laboratory systems/services, one or more ancillary medical service systems, one or more Pharmacy Benefit Management (PBM) and/or Specialty Prescription Management (SPM) services used by physicians to process medical prescriptions, e.g., Express Scripts®, and the like.

In some embodiments, the retail pharmacy 24₁ is part of a larger retail pharmacy enterprise having multiple retail pharmacies 24₂-24_{L} located external to the hospital 12. One or more such external retail pharmacies 24₂-24_{L} may be located nearby the hospital, e.g., within some predefined distance from the hospital 12, such as less than 20, 10, 5, 2 or 1 mile(s) from the hospital. One or more other such external retail pharmacies 24₂-24_{L} may be located remote from the hospital 12, e.g., in another town, city, county, region or state, and one or more other such external retail pharmacies 24₂-24_{L} may be co-located with one or more other hospitals.

In other embodiments, the retail pharmacy 24₁ is part of a larger retail enterprise sometimes referred to as a “Big-Box Store,” “Superstore,” Supercenter” or “Megastore,” having multiple external retail outlets or stores 24₂-24_{L}, each which include therein multiple product/service departments. Examples of such product/service departments include, but are not limited to, a bakery, a pharmacy department, a meat department, a seafood department, a dairy department, a produce department, a beverage department, a frozen food department, a photograph developing service department, an electronics department, a sporting goods department, a nursery, a seasonal goods department, a clothing department, a footwear department, a pet food and/or accessory department, an automotive goods department, and kitchenware department, a houseware department, a hardware and/or tool department, an outdoor and/or gardening department, and the like. In some embodiments, one or more such retail stores or outlets 24₂-24_{L} may not be organized in the form of product and/or service departments but nonetheless offer items for retail sale in any one or more of the foregoing product/service department categories. In any case, one or more of the multiple external retail outlets or stores 24₂-24_{L} having a retail pharmacy therein may be located nearby the hospital 12 and/or one or more may be located remote from the hospital 12.

In still other embodiments, the retail pharmacy 24₁ may be a sole or stand-alone retail pharmacy, i.e., not part of a larger retail pharmacy enterprise or other retail enterprise. It will be understood that in such embodiments there will be no external retail pharmacies and/or stores 24₂-24_{L}.

In embodiments in which the retail pharmacy 24₁ is part of a larger retail pharmacy enterprise having multiple external retail pharmacies 24₂-24_{L}, all such retail pharmacies 24₁-24_{L} will be understood to be “affiliated,” meaning that all such retail pharmacies 24₁-24_{L} are owned or otherwise controlled, directly or indirectly through one or more intermediaries, by a common business entity. All other retail pharmacies will be understood to be non-affiliated, i.e., not affiliated with any of the retail pharmacies 24₁-24_{L}. Likewise, in embodiments in which the retail pharmacy 24₁ is part of a larger retail enterprise having multiple external retail outlets or stores 24₂-24_{L}, some or all of which have a retail pharmacy or pharmacy department therein and may also have one or more other product/service departments therein, the retail pharmacy 24₁ and all such retail outlets or stores 24₂-24_{L} will be understood to be “affiliated,” meaning that the retail pharmacy 24₁ all such retail stores or outlets 24₂-24_{L} are owned or otherwise controlled, directly or indirectly through one or more intermediaries, by a common business entity. All other retail pharmacies and retail enterprises will be understood to be non-affiliated, i.e., not affiliated with the retail pharmacy 24₁ or with any of the multiple external retail stores or outlets 24₂-24_{L}.

In embodiments in which the retail pharmacy 24₁ is part of a larger retail pharmacy enterprise or part of a larger, more general retail enterprise, the system 10 further illustratively includes a pharmacy server 60 external to the hospital 12 and external to the retail pharmacy 24₁, and communicatively coupled to the retail pharmacy 24₁ via a conventional private network 62. In such embodiments, the pharmacy server 60 is operable to manage, at least in part, business operations of the retail pharmacy 24₁ and also of the multiple retail pharmacies 24₂-24_{L}. In some embodiments, the system may further include one or more so-called hub servers positioned between the pharmacy server 60 and one or more of the retail pharmacies 24₁-24_{L} and/or between the pharmacy server 60 and one or more subsets or groups of the retail pharmacies 24₁-24_{L}, and in such embodiments, the pharmacy server 60 may act as a conventional master server and all such hub servers may act as conventional slave servers. In any case, it will be understood that in embodiments in which the retail pharmacy 24₁ is part of a larger, more general retail enterprise, the pharmacy server 60 may be or include a more general enterprise server operable to manage, at least in part, business operations of the retail pharmacy 24₁ and also of the multiple retail outlets or stores 24₂-24_{L}. In embodiments in which the retail pharmacy 24₁ is a sole or stand-alone retail pharmacy, the pharmacy server 60 may be co-located with the retail pharmacy 24₁, co-located in the hospital 12 but separate from the retail pharmacy 24₁ or external to the hospital 12 as illustrated in FIG. 1.

The hospital server 14 may be embodied as any type of server or similar computing device capable of performing the conventional functions thereof as well as the functions described herein. In the illustrative embodiment of FIG. 1, the hospital server 14 includes a processor 26, an I/O subsystem 28, a memory 30, a data storage 32, a communication circuitry 34, and one or more peripheral devices 38. It should be appreciated that the hospital server 14 may include other components, sub-components, and devices commonly found in a server and/or computing device, which are not illustrated in FIG. 1 for clarity of the description.

The processor 26 of the hospital server 14 may be embodied as any type of processor capable of executing software/firmware, such as a microprocessor, digital signal processor, microcontroller, or the like. The processor 26 may be a single processor or include multiple processors. The I/O subsystem 28 of the hospital server 14 may be embodied as conventional circuitry and/or components to facilitate input/output operations with the processor 26 and/or other components of the hospital server 14. The processor 26 is communicatively coupled to the I/O subsystem 28.

The memory 30 of the hospital server 14 may be embodied as or otherwise include one or more conventional volatile and/or non-volatile memory devices. The memory 30 is communicatively coupled to the I/O subsystem 28 via a number of signal paths. Although only a single memory device 30 is illustrated in FIG. 1, the hospital server 14 may include additional memory devices in other embodiments. Various data and software may be stored in the memory 30. The data storage 32 is also communicatively coupled to the I/O subsystem 28 via a number of signal paths, and may be embodied as any type of device or devices configured for the short-term or long-term storage of data such as, for example, memory devices and circuits, memory cards, hard disk drives, solid-state drives, or other data storage devices.

The communication circuitry 34 of the hospital server 14 may include any number of devices and circuitry for enabling communications between the hospital sever 14 and the one or more third-party systems 76 main server 12, and between the hospital server 14 and a pharmacy server 60 for purposes which will be described in detail below. In the illustrated embodiment, the communication circuitry 34 illustratively includes a conventional local area wireless communication network 36, e.g. a WiFi system or network, for providing for wireless communications between mobile computers and/or mobile communication devices operating within the hospital 12 and one or more outside or external systems via the private, e.g., secure, network 62 and/or via a public network such as the Internet; i.e., a publicly accessible global system of interconnected computer networks. Examples of such outside or external systems include, but are not limited to, the pharmacy server 60, for purposes which will be described herein, any information source comprising part of the World-Wide-Web (WWW), and the like. Generally, the communication circuitry 34 may be configured to use any one or more, or combination, of conventional secure and/or unsecure communication protocols to communicate with the one or more third-party systems 76 and with the pharmacy server 60. As such, the system 10 may include any number of additional devices, such as additional computers, routers, and switches, to facilitate such communications.

The peripheral devices 38 of the hospital server 14 may include any number of conventional peripheral devices including for example, but not limited to, any number of input/output devices, interface devices, display monitors, audio and/or video processing devices, and/or other peripheral devices.

The retail pharmacy 24₁ illustratively includes many of the same components as the hospital server 14, such as a processor 40, an I/O subsystem 42, one or more memory devices 44, a data storage 46, communication circuitry 48 and any number of conventional peripheral devices 52. Additionally, the retail pharmacy further includes one or more conventional point-of-sale systems 50 for processing purchases made by customers of the retail pharmacy 24₁. In some embodiments, each of the foregoing components may be identical to corresponding components of the hospital server 14 described above, and a detailed explanation of such components will not be repeated here for brevity. In other embodiments, one or more of the foregoing components may be configured differently than the hospital server 14 described above. In some embodiments, the communication circuitry 48 is communicatively coupled to the communication circuitry 34 of the hospital sever 14 as shown by dashed-line representation in FIG. 1, and communications between the retail pharmacy 24₁ and the hospital server 14 may take place between the communication circuitry 48 and the communication circuitry 34 respectively using any conventional secure communication protocol. In any case, the communication circuitry 48 is communicatively coupled to the private network 62, and communications between the retail pharmacy 24₁ and the pharmacy server 60 are conducted via the network 62 typically using any conventional secure communication protocol.

Further depicted in FIG. 1 are a number of conventional wireless signal broadcasting devices 54 each illustratively coupled to the I/O subsystem 42 of the retail pharmacy 24₁ and/or to the pharmacy server 60 via the private network 62. In some alternative embodiments, one or more of the wireless signal broadcasting devices 54 may be coupled to the hospital server 14 as illustrated in FIG. 1. In one embodiment, the one or more wireless signal broadcasting devices 54 is/are provided in the form of one or more conventional electronic beacons, e.g., conventional radio beacons, for the purpose of broadcasting radio signals carrying information corresponding to the location and/or identity thereof. The wireless signal broadcasting devices 54 will, for purposes of this disclosure, be described as being implemented in the form of such beacons, although it will be understood that one or more of the wireless signal broadcasting devices 54 may alternatively take the form of one or more other conventional wireless signal broadcasting devices configured and operable to broadcast or otherwise emit or transmit wireless identification signals carrying information corresponding to the location and/or identity of thereof. Examples of such other electronic devices may include, but are not limited to, transponders, radio-frequency identification (RFID) devices, near-field communication (NFC) devices, far-field communication devices, telemetry devices, automated identification and data capture (AIDC) devices, and the like.

Illustratively, the beacons 54 are positioned at, near, or adjacent to at least one entrance/exit 25 to/from the hospital 12 as illustrated in FIG. 1, and in some embodiments one or more beacons 54 is/are positioned at, near or adjacent to each entrance/exit to/from the hospital 12 via which a patient or an authorized caregiver of the patient may pass. In any case, each such beacon 54 is thus associated with, and therefore identifies, an entrance/exit to/from the hospital 12, and each such beacon 54 is illustratively configured to periodically broadcast one or more unique wireless identification signals, i.e., one or more identification signals that distinguish the particular beacon 54 from others of the beacons 54.

In some embodiments, the one or more beacons 54 are each configured to periodically broadcast wireless identification signals in the radio frequency (RF) range, although any of the one or more beacons 54 may be configured to alternatively broadcast wireless identification signals in one or more other frequency ranges. In any case, the one or more beacons 54 are further each illustratively configured to broadcast wireless identification signals with a predefined broadcast range and/or orientation (i.e., direction). Illustratively, the unique wireless identification signals broadcast by each beacon 54 carries decodable information in the form of a unique identification code (UID). Generally, the UID of each beacon 54 uniquely identifies that beacon and distinguishes that beacon from all other beacons within the hospital 12 such that determination or identification of any UID maps that particular beacon 54 to a specific entrance/exit 25 of the hospital 12. Those skilled in the art will recognize additional and/or alternative information that may be included within or appended to the UID, and/or carried by the unique wireless identification signals broadcast by the beacons 54, and it will be understood that any such additional and/or alternative information is contemplated by this disclosure.

An embodiment of the pharmacy server 60 is also illustrated in FIG. 1, and generally includes the same components as the hospital server 14. For example, a processor 64 is coupled to an I/O subsystem 66, and the I/O subsystem 66 is coupled to a memory 68, a data storage unit 70, communication circuitry 72 and one or more peripheral devices 74. In some embodiments, each of the foregoing components may be identical to corresponding components of the hospital server 14 described above, and a detailed explanation of such components will not be repeated here for brevity. In other embodiments, the pharmacy server 60 may be configured differently than the hospital server 14 described above. In any case, the communication circuitry 72 of the pharmacy server 60 is coupled to the private network 62 for conducting communication with the hospital server 14, the co-located retail pharmacy 24₁, the one or more external retail pharmacies and/or stores 24₂-24_{L}, one or more of the beacons 54, one or more of the one or more third-party systems 76, and one or more caregiver computers 90₁-90_{N} which will be described in detail below. Additionally, the communication circuitry 72 is configured and operable to conduct communication with any number of mobile communication devices 80₁-80_{M} as will be described in detail hereinafter. When any such mobile communication device (MCD) 80₁-80_{M} is outside of the hospital 12, communications, typically secure communications, between the pharmacy server 60 and the MCD 80₁-80_{M} may illustratively take place via a public network or the private network 62, whereas such communications illustratively take place via a combination of the WiFi network 36 and the private network 62 when the MCD 80₁-80_{M} is within the hospital 12 as illustrated in FIG. 1. Although only one such pharmacy server 60 is shown in FIG. 1, it should be appreciated that, in other embodiments, the system 10 may include any number of interconnected pharmacy servers, and in still other embodiments the pharmacy server 60 may be communicatively coupled to one or more remote servers of the retail pharmacy enterprise or general retail enterprise. In such embodiments, the one or more remote servers may include any structure or feature illustrated and described herein with respect to the pharmacy server 60, and may be configured to execute any one or more functions described herein with respect to the pharmacy server 60 either alternatively to the pharmacy server 60 or in addition to the pharmacy server 60. In any case, the pharmacy server 60 may generally be embodied as any type of server or similar computing device capable of performing the functions described herein.

The mobile communication devices 80₁-80_{M} illustrated in FIG. 1 are intended to depict mobile communication devices that are each separately owned and/or operated by a different patient or by an authorized caregiver of a patient. No limit on the total number of such mobile communication devices 80₁-80_{M} that may be owned and operated by any one patient or by any of one or more authorized caregivers of a patient, or on the total number of such mobile communication devices 80₁-80_{M} that may communicate with the pharmacy server 60, is intended or should be inferred. The mobile communication devices 80₁-80_{M} may be or include any mobile electronic device capable of executing one or more software application programs as described herein and of communicating with the pharmacy server 60 as described herein. Examples of the mobile communication devices 80₁-80_{M} include, but should not be limited to, mobile telephones, smart phones, laptop computers, notebook computers, tablet computers, personal data assistants (PDAs), and the like.

The caregiver computers 90₁-90_{N} illustrated in FIG. 1 are intended to include any of privately owned and accessed computers, such as those residing in residences, offices and/or business of authorized caregivers of one or more patients admitted to the hospital 12, and to include semi-privately owned and accessed computers, such as those residing at multiple-employee business enterprises, as well as publicly accessible computers, such as those available at internet café s and kiosks, which may be accessed by one or more such authorized caregivers. The caregiver computers 90₁-90_{N} may be or include any computer capable of executing one or more software programs and of communicating with the pharmacy server 60 via the network 62 for various purposes as described herein. Examples of caregiver computers 90₁-90_{N} include, but should not be limited to, personal computers (PCs), laptop computers, notebook computers, tablet computers, and the like, whether or not networked with one or more other computing devices.

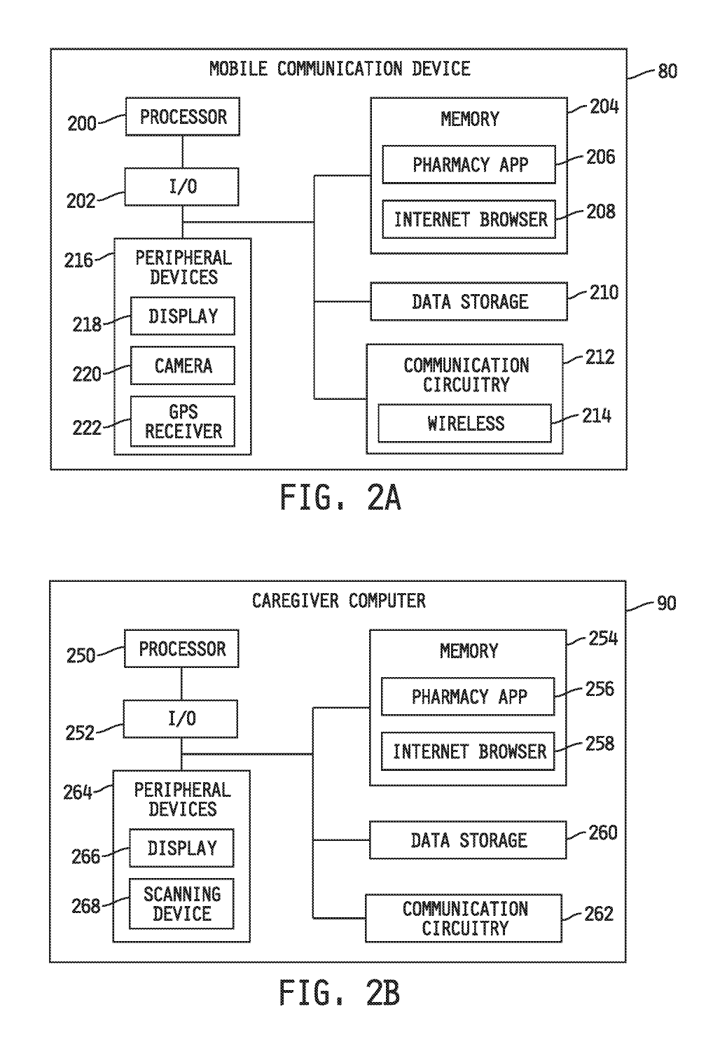

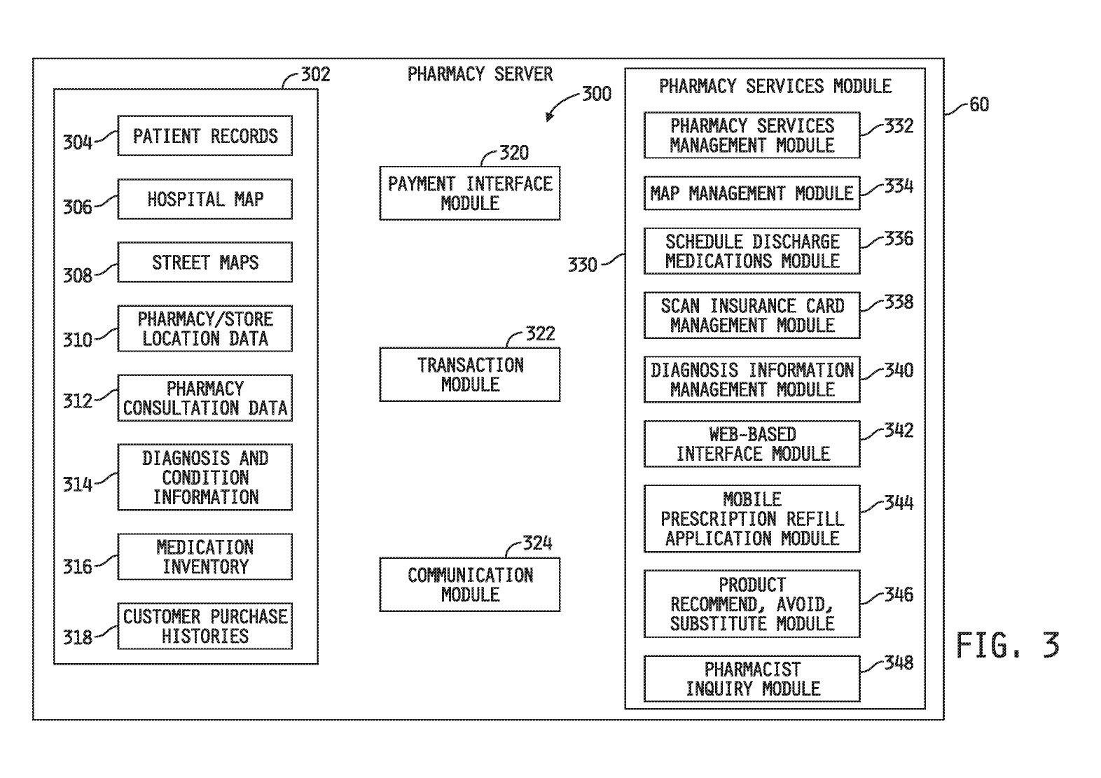

Referring now to FIG. 2A, an embodiment of one of the mobile communication devices (MCDs) 80 illustrated in FIG. 1 is shown, which includes components similar to the hospital server 14 and also to the pharmacy server 60 such as a processor 200, an I/O subsystem 202, a memory 204, a data storage 210, communication circuitry 212 and a number of peripheral devices 216. In some embodiments, each of the foregoing components may be identical to corresponding components of the hospital server 14 or pharmacy server 60 described above, and a detailed explanation of such components will not be repeated here for brevity. In other embodiments, any of the one or more mobile communication devices 80₁-80_{M} may be configured differently than the server 14 and/or 60 described above. It will be appreciated that one or more of the mobile communication devices 80₁-80_{M} may include other components, sub-components, and devices commonly found in a computer and/or computing device.

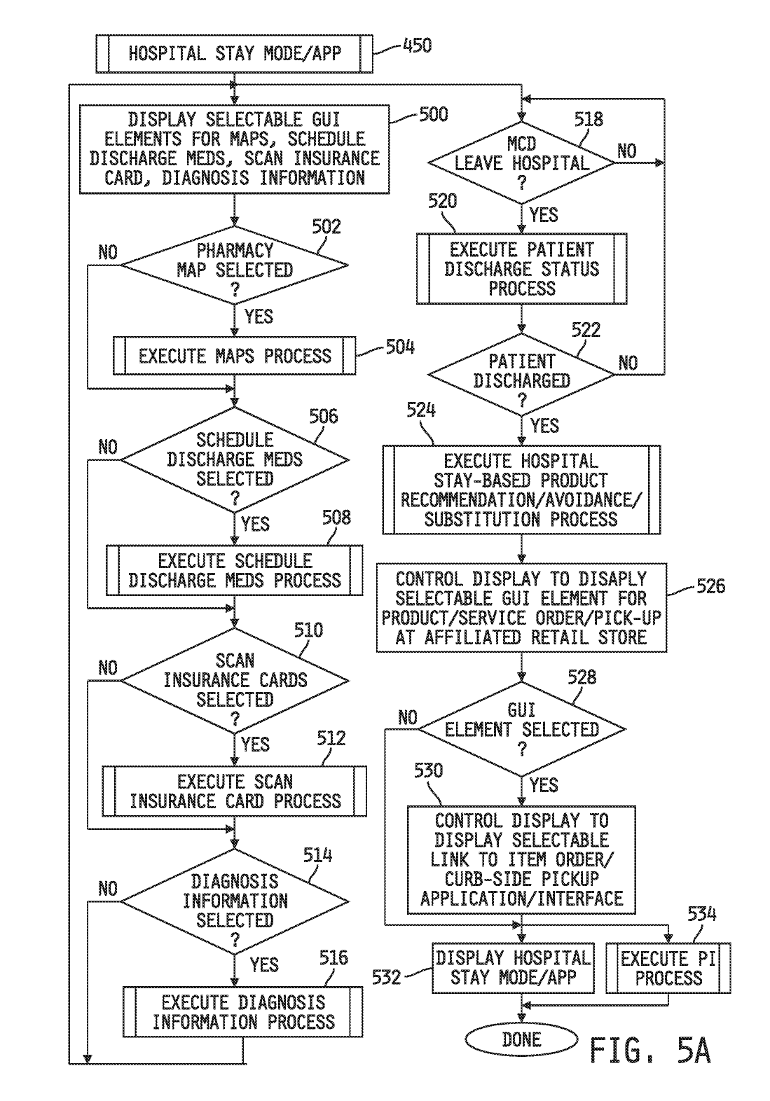

The memory 204 illustratively includes pharmacy application 206 in the form of, e.g., instructions executable by the processor 200 to provide pharmacy services and/or information to the user of the MCD 80, to conduct communications relating thereto with the pharmacy server 60, to facilitate user input of information to the pharmacy server 60 and to facilitate display to the user of information provided by the pharmacy server 60. An example embodiment of at least some operational aspects of the pharmacy application 206 will be described in greater detail hereinafter with respect to FIGS. 4-9. The memory 204 further illustratively includes stored therein a conventional internet browser 208 in the form of, e.g., instructions executable by the processor 200 to access the Internet and navigate the WWW.

The communication circuitry 212 illustratively includes conventional wireless communication circuitry 214 configured to facilitate communication with the pharmacy server 60 via a public or private network when outside of the hospital 12, and via a combination of the hospital WiFi network 36 and the private network 62 when inside the hospital 12. In either case, the mobile communication device 80 may use any suitable communication protocol to communicate with the pharmacy server 60.

In addition to, or alternatively to, the number of peripheral devices 38 of the hospital server 14 and/or to the number of peripheral devices 74 of the pharmacy server 60 as described above, the number of peripheral devices 216 of the mobile communication device 80 may include any number of other or additional peripheral or interface devices. For example, in the embodiment illustrated in FIG. 2A, the peripheral devices 216 of the mobile communication device 80 include a conventional display device or screen 218, a conventional camera 220 and a conventional global positioning system (GPS) receiver 222.

Referring now to FIG. 2B, an embodiment of one of the caregiver computers 90 illustrated in FIG. 1 is shown, which includes components similar to the hospital server 14 and also to the pharmacy server 60 such as a processor 250, an I/O subsystem 252, a memory 254, a data storage 260, communication circuitry 262 and a number of peripheral devices 264. In some embodiments, each of the foregoing components may be identical to corresponding components of the hospital server 14 or pharmacy server 60 described above, and a detailed explanation of such components will not be repeated here for brevity. In other embodiments, any of the one or more caregiver computers 90₁-90_{N} may be configured differently than the server 14 and/or 60 described above. It will be appreciated that one or more of the caregiver computers 90₁-90_{N} may include other components, sub-components, and devices commonly found in a computer and/or computing device.

The communication circuitry 262 illustratively includes conventional communication circuitry configured to facilitate communication with the pharmacy server 60 via the network 62, and the caregiver computer 90 may use any suitable communication protocol to communicate with the pharmacy server 60. In addition to, or alternatively to, the number of peripheral devices 38 of the hospital server 14 and/or to the number of peripheral devices 74 of the pharmacy server 60 described above, the number of peripheral devices 264 of the caregiver computer 90 may include any number of other or additional peripheral or interface devices. For example, in the embodiment illustrated in FIG. 2B, the peripheral devices 264 of the caregiver computer 90 include a conventional display device, monitor or screen 266 and a conventional document/photo scanning device 268.

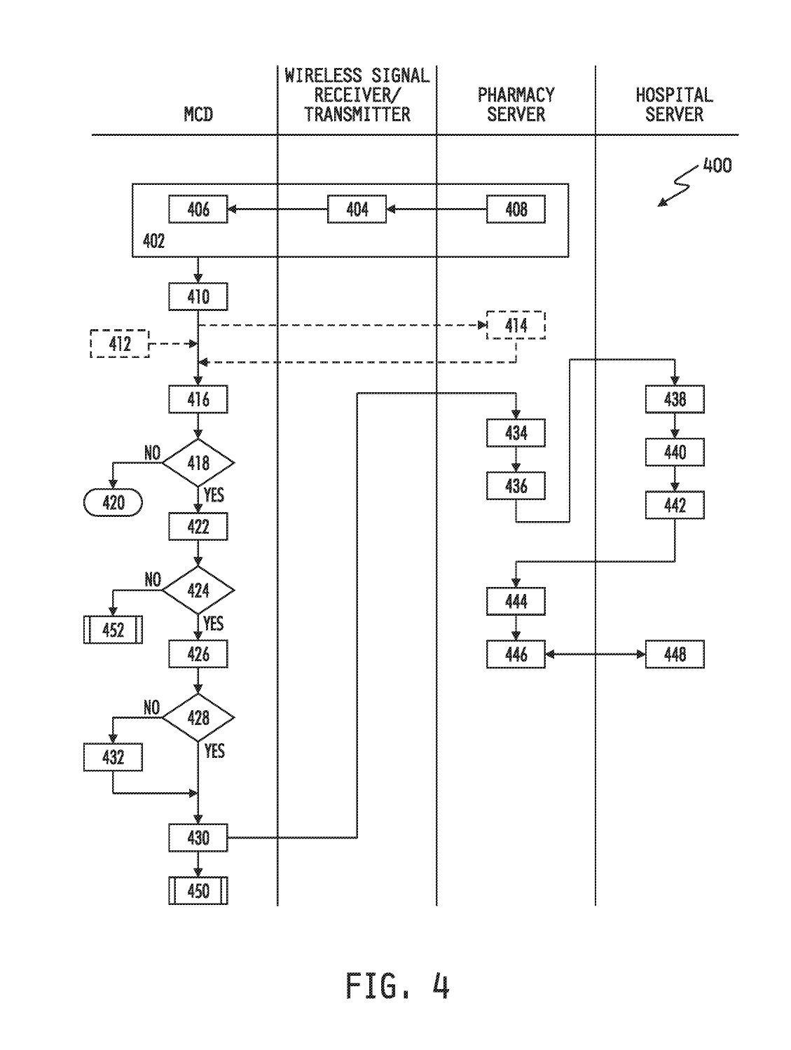

Referring now to FIG. 3, a simplified block diagram is shown of an embodiment of an environment 300 of the pharmacy server 60 illustrated in FIG. 1. In the embodiment shown in FIG. 3, the environment 300 includes a server database 302 which illustratively includes patient records portion 304, a hospital map portion 306, a street maps portion 308, a pharmacy/store location data portion 310, a pharmacy consultation data portion 312, a diagnosis and condition information portion 314, a medication inventory portion 316 and a patient purchase history portion 318.

Customers may elect to participate in an enterprise membership services (EMS) program offered, managed and maintained by the retail pharmacy enterprise in embodiments in which the retail pharmacy 24₁ is part of a larger retail pharmacy enterprise, or by the general retail enterprise in embodiments in which the retail pharmacy 24₁ is part of a larger, general retail enterprise, by establishing a user account (which may be referred to herein as an “EMS account” or “customer account”) within the server 60, which user account may in some cases be an individual account accessible only by an individual person, e.g., an individual customer, and in other cases may be a group or “household” account accessible by each of a plurality of members of a predefined group of persons, e.g., members of a family or household, one or more employees of a business enterprise, etc. The terms “member,” “customer” and “user,” and variants thereof, are used interchangeably in the following description, and such terms should be understood to refer interchangeably to an individual customer or a predefined group of individual customers (referred to herein as a “household”) who shop at and purchase items from the retail pharmacy enterprise or the general retail enterprise, and who are members of an enterprise membership service (EMS) of the type described herein and provided and managed by the retail pharmacy enterprise or general retail enterprise.

Illustratively, a software application program is available for download from the pharmacy server 60 for customers electing to access the EMS program via a mobile communication device, e.g., one of the mobile communication devices 80₁-80_{M}. In one embodiment, the pharmacy application 206 illustrated in FIG. 2A is, is one aspect of or is operatively linked to, such a software application program. Once downloaded and activated, customers of the retail pharmacy enterprise or the general retail enterprise can access and manage their EMS account and pharmacy services and/or other program features via the software application program executed by their mobile communication device 80₁-80_{M}. Illustratively, the pharmacy server 60 additionally hosts and controls an EMS website or web-based interface accessible via the private network 62 or via another secure network, and in such embodiments customers of the retail pharmacy enterprise or the general retail enterprise can access and manage their EMS accounts and pharmacy services and/or other program features by accessing their EMS page(s) of the EMS website or web-based interface hosted by the pharmacy server 60 via their mobile communication device 80₁-80_{M} using the internet browser 208.

In the illustrated embodiment, the patient records data 304 of the server database 302 has stored therein information relating to user accounts and user profile data for each of the members of the EMS program. As customers join the EMS program, the server 60 establishes an EMS account within the patient records data 304 that is unique to the customer, and assigns to the customer, and/or the customer selects, a unique, corresponding enterprise membership services identification code, EMSID. The EMSID associated with each customer is entered into the server 60, is stored along with the customer's profile data in the patient records data 504, and can be used thereafter to access the customer's EMS account. A record of each prescription filled by one of the retail pharmacies 24₁-24_{M} for and purchased by a customer, and records of each additional purchase made from one of the retail pharmacies 24₁-24_{M} by a customer, in which the customer is identified to the point-of-sale system 50 (and thus to the pharmacy server 60) is recorded in the customer purchase history data 318 and linked to the corresponding customer in the patient records data 304 associated with that customer's EMS account. Thus, the patient records data 304 contains for each customer member at least the customer's personal identification information, e.g., including name, address, email address, mobile telephone number, etc. and the customer's associated EMSID, and the customer purchase history data 318 contains purchase history for each item purchased by that customer for which the customer was identified to the pharmacy server 60 as a customer-member of the EMS program, e.g., by providing the customer's EMSID to the point-of-sale system 50 before, during or after the purchase. In some embodiments, the customer purchase histories 318 also contain records of purchases made by each customer-member of the EMS program at any of one or more retail stores having common ownership or otherwise affiliated with the one or more retail pharmacies 24. Examples of such purchases may include, but are not limited to, purchases of any one or combination of food, clothing, hardware, electronics, sporting goods, seasonal items, lawn and garden items, houseware items and the like.

The hospital map portion 306 of the server database 302 illustratively has stored therein one or more maps of the internal layout, or portions thereof, of the hospital 12. Such one or more maps are illustratively stored in the form of 2-dimensional graphic images modifiable by the processor 64 to show route guidance information to and/or from patient-accessible and/or patient caregiver-accessible areas of the hospital 12, including, but not limited to, the patient rooms 16, medical procedure rooms 18, offices 20, reception or check-in area(s) 22, the chapel 23, the cafeteria 27, the gift shop 29, the retail pharmacy 24₁, hallways, elevators, stairs and/or other areas of the hospital 12. The street maps portion 308 of the server database 302 illustratively has stored therein one or more sets of street maps identifying routes from the hospital 12 to one or more nearby retail pharmacies and/or stores 24₂-24_{L}. Such one or more sets of maps are illustratively stored in the form of 2-dimensional graphic images showing, or modifiable by the processor 64 to show, route guidance information between the hospital 12 and the one or more nearby retail pharmacies and/or stores 24₂-24_{L}. In some alternative embodiments, local street map information, i.e., local to the hospital 12, may be obtained by the pharmacy server 60 from publicly available sources, and in such embodiments the street maps portion 308 of the server database 302 need not be populated with street map information.

The pharmacy/store location data portion 310 of the server database 302 illustratively has stored therein geographic location information, e.g., in the form of geographic coordinates, street addresses and/or other information, for each of the retail pharmacies and/or stores 24₁-24_{L} in the retail enterprise, or at least for those retail pharmacies and/or stores 24₁-24_{L} of the retail enterprise that are within a predefined distance or radius of the hospital 12.

The pharmacy consultation data portion 312 of the server database 302 illustratively has stored therein pharmacy representative availability and scheduling information relating to pharmacy consultation services provided by the retail pharmacies 24₁-24_{L} and available upon request to patients and authorized caregivers of patients of the hospital 12. In some embodiments, the pharmacy consultation data portion 312 further includes pharmacist information, i.e., information relating to the one or more pharmacists, and in some embodiments other pharmacy representatives, employed by the one or more retail pharmacies 24. Such information may include, but is not limited to, name, location (state, city and/or store address), work schedule, contact information, e.g., pharmacy telephone number, pharmacy-issued cell phone number, personal cell phone number, email address(es), etc., and one or more professional and/or personal attributes. Such attributes may illustratively include, but are not limited to, educational degree(s) earned, educational institution(s) attended, experience or skill level with one or more durable medical equipment (DME) items, experience or skill level with one or more medical diagnoses, experience or skill level with one or more medical procedures experience or skill level with one or more medications, with side effects of one or more medications, with interactions between one or more medications and one or more other medications, interactions between one or more medications and one or more food items, beverages or other ingestible matter, interactions between one or more medications and one or more topically-applied medications or products and/or interactions between one or more medications and one or more products or items with which humans may come into contact, and the like.

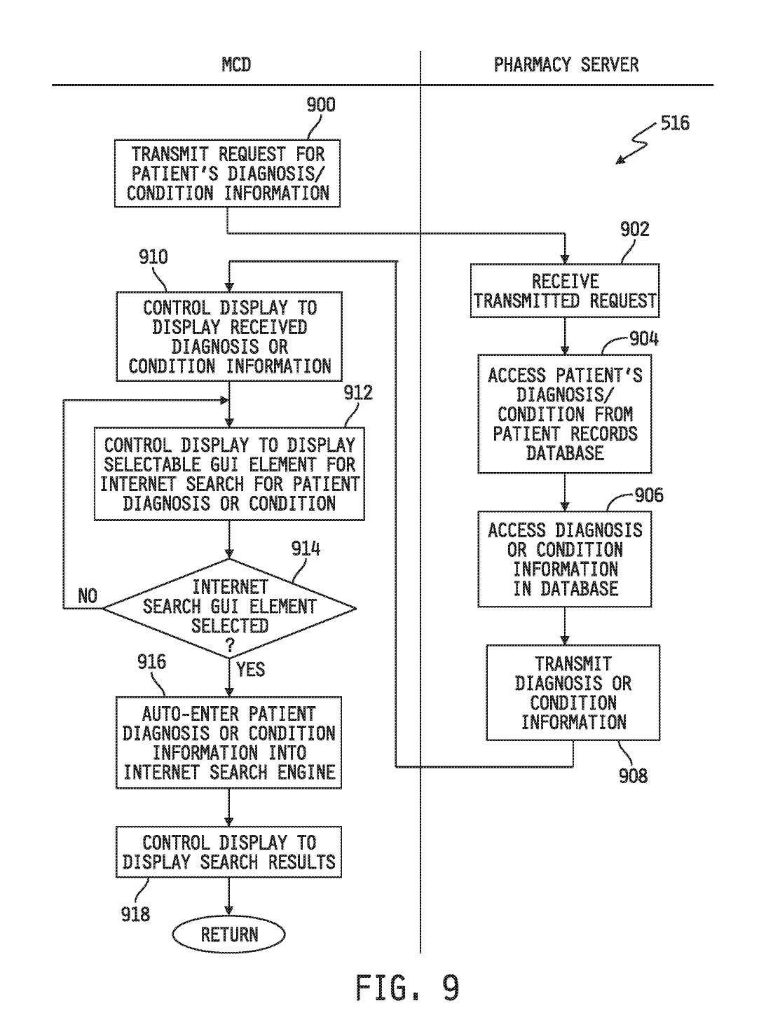

The diagnosis and condition information portion 314 of the server database 302 is illustratively a library of information relating to various medical diagnoses and medical conditions that patients may have. As will be described in detail with respect to FIG. 9, such information may be made available and provided upon request to patients and authorized caregivers of patients of the hospital 12.

The medication inventory portion 316 of the server database 302 illustratively has stored therein information relating to inventory, sales and ordering of and for each medication and other prescribable item, e.g., durable medical equipment and/or other items, and for each otherwise purchasable item (i.e., over-the-counter or OTC items, in each of the retail pharmacies or stores 24₁-24_{L}.

The environment 300 of the pharmacy server 60 further includes a payment interface module 320, a transaction module 322 and a communication module 324. In one embodiment, the payment interface module 320 is configured, in a conventional manner, to process tangible forms of electronic payment systems (EPS), e.g., tangible electronic funds transfer instruments such as credit cards, debit cards, etc., used at the point-of-sale system(s) of the various retail pharmacies and/or stores 24₁-24_{L}. In an example of such embodiments, the payment interface module 320 illustratively is or includes a conventional magnetic strip reading device configured to read payment information stored in magnetic form on a strip affixed to a conventional credit or debit card. Alternatively or additionally, the payment interface module 320 may be or include one or more other conventional devices or mechanisms for transferring or facilitating the transfer of electronically readable customer payment system (EPS) information stored on other electronic or non-electronic media, and/or stored on, or accessible by, one of the mobile communication devices 80₁-80_{M} or one of the caregiver computers 90₁-90_{N}.

The transaction module 322 is configured to monitor purchases of products and services made by shopper members of the EMS program using any of the point-of-sale systems 50 of any of the retail pharmacies and/or stores 24₁-24_{L}, and to store purchase transaction data associated with such purchases in the patient records data 304. As described above, the patient records data 304 is illustratively partitioned or otherwise configured to store such purchase transaction data in a manner that provides for the separate tracking and identification of purchase history of each customer member.

The communication module 324 is configured, in a conventional manner, to control and manage all communications between the pharmacy server 60 and the retail pharmacy 24₁, to control and manage all communications between the pharmacy server 60 and the various retail pharmacies 24₂-24_{L}, to control and manage all communications between the pharmacy server 60 and the hospital server 14, to control and manage all communications between the pharmacy server 60 and the one or more third-party systems 76, to control and manage all communications between the pharmacy server 60 and the various mobile communication devices 80₁-80_{M}, and to control and manage all communications between the pharmacy server 60 and the various caregiver computers 90₁-90_{N}.

The environment 300 of the pharmacy server 60 further illustratively includes a pharmacy services module 330 which illustratively includes a pharmacy services management module 332, a map management module 334, a schedule discharge medications management module 336, a scan insurance card management module 338, a diagnosis information management module 340, a web-based interface module 342, a mobile prescription refill application module 344, a product recommendation, avoidance and/or substation module 346 and a pharmacist inquiry module 348.

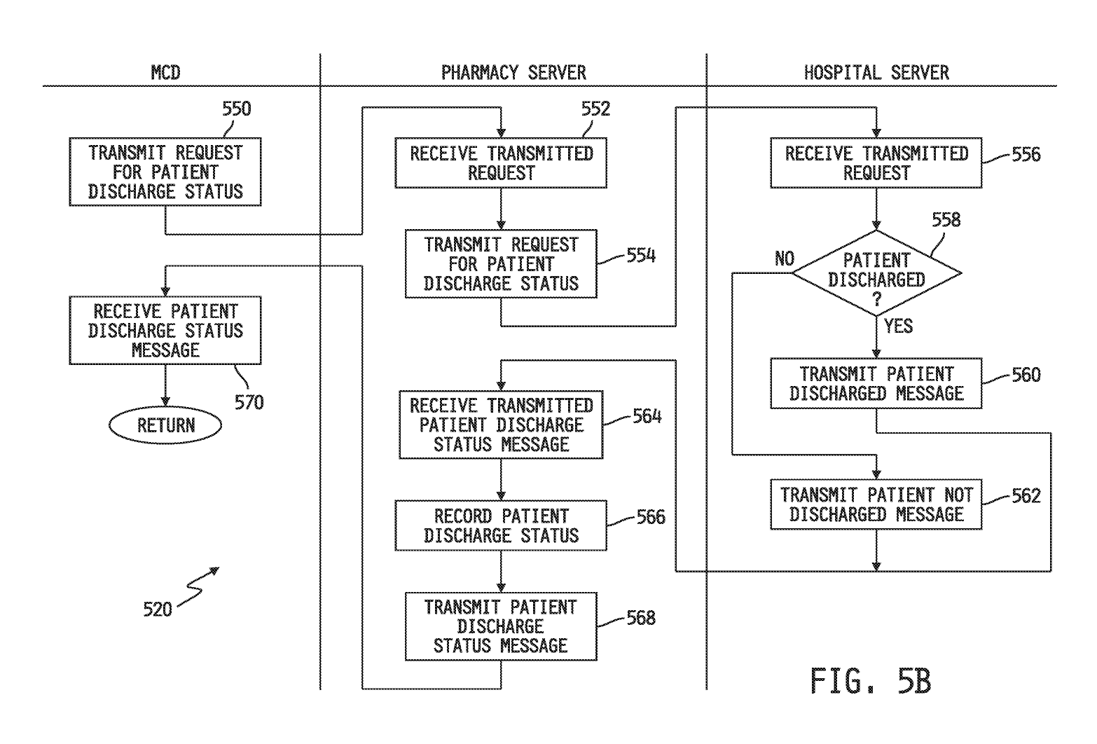

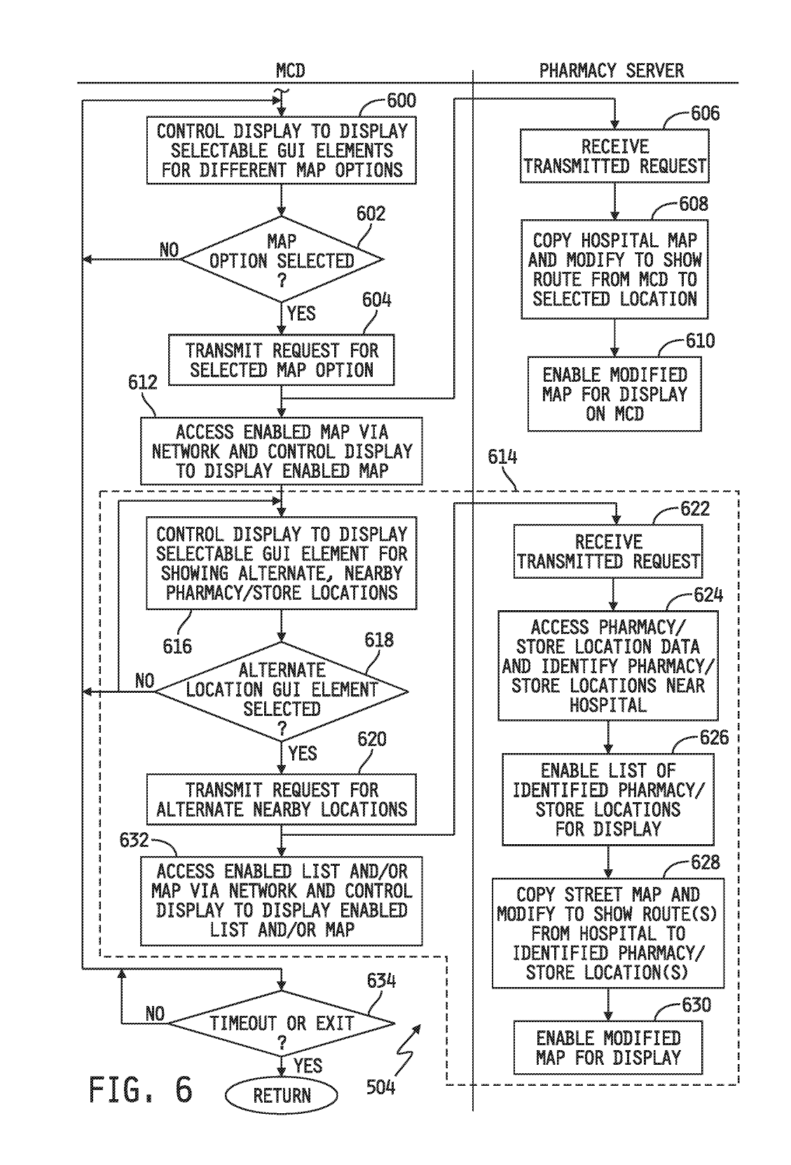

The pharmacy services management module 332 is illustratively operable to manage and control recognition and identification of mobile communication devices 80₁-80_{M} upon entry to/exit from the hospital 12, to execute various pharmacy service processes accessed by MCDs 80₁-80_{M} of patients admitted to the hospital 12, by MCDs 80₁-80_{M} of one or more authorized caregivers of patients admitted to the hospital 12 and/or by caregiver computers 90₁-90_{N} of one or more authorized caregivers of patients admitted to the hospital 12, and to monitor the admittance/discharge statuses of such patients. The pharmacy services management module 332 is further illustratively contains information about each of the one or more beacons 54 located at one or more corresponding entrances/exits 25 of the hospital 12, e.g., location(s) of the one or more beacons 54 within the hospital, UID(s) of the one or more beacons 54, etc. Example embodiments of processes executed by the pharmacy services management module 332 are illustrated in FIGS. 4 and 5B, and such processes will be described in detail hereinafter.

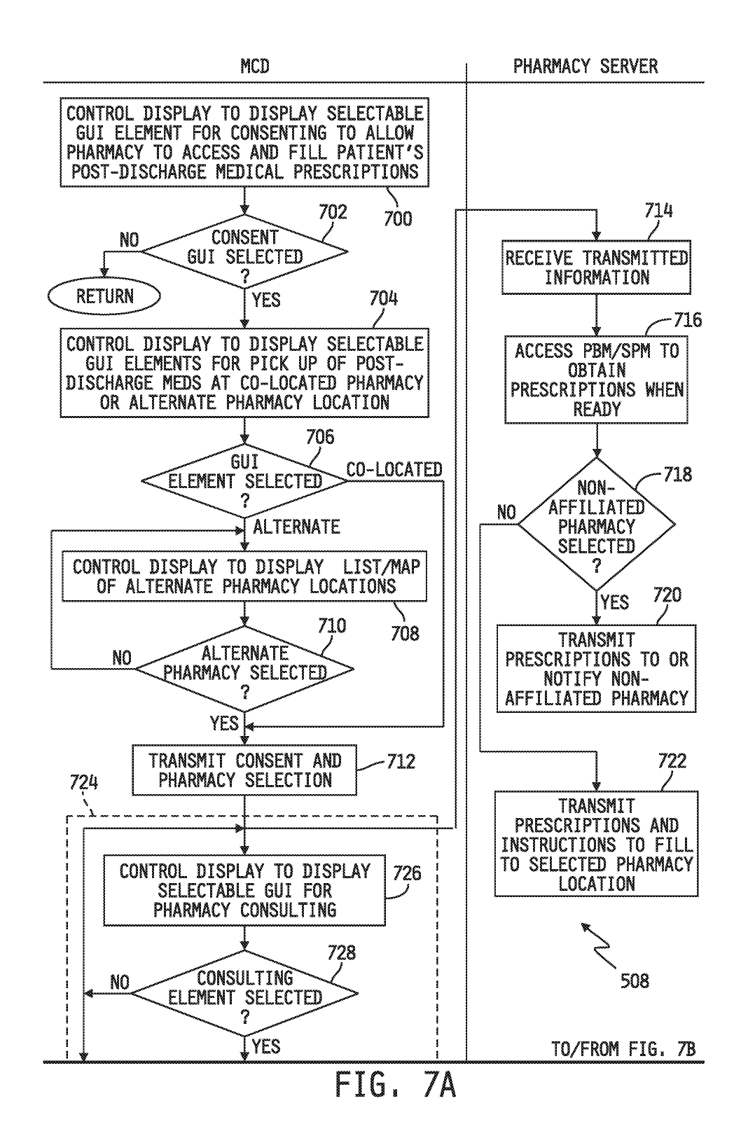

The map management module 334 is illustratively operable to retrieve and modify for viewing on a display 218 of an MCD 80₁-80_{M} and/or on a display 266 of a caregiver computer 90₁-90_{N} maps, illustratively with route guidance, of some or all of the internal layout of the hospital 12 and/or of street locations of one or more of the retail pharmacies and/or stores 24₂-24_{L} external to and nearby the hospital 12. An example embodiment of a process executed by the maps management module 334 is illustrated in FIG. 6, and such a process will be described in detail hereinafter.

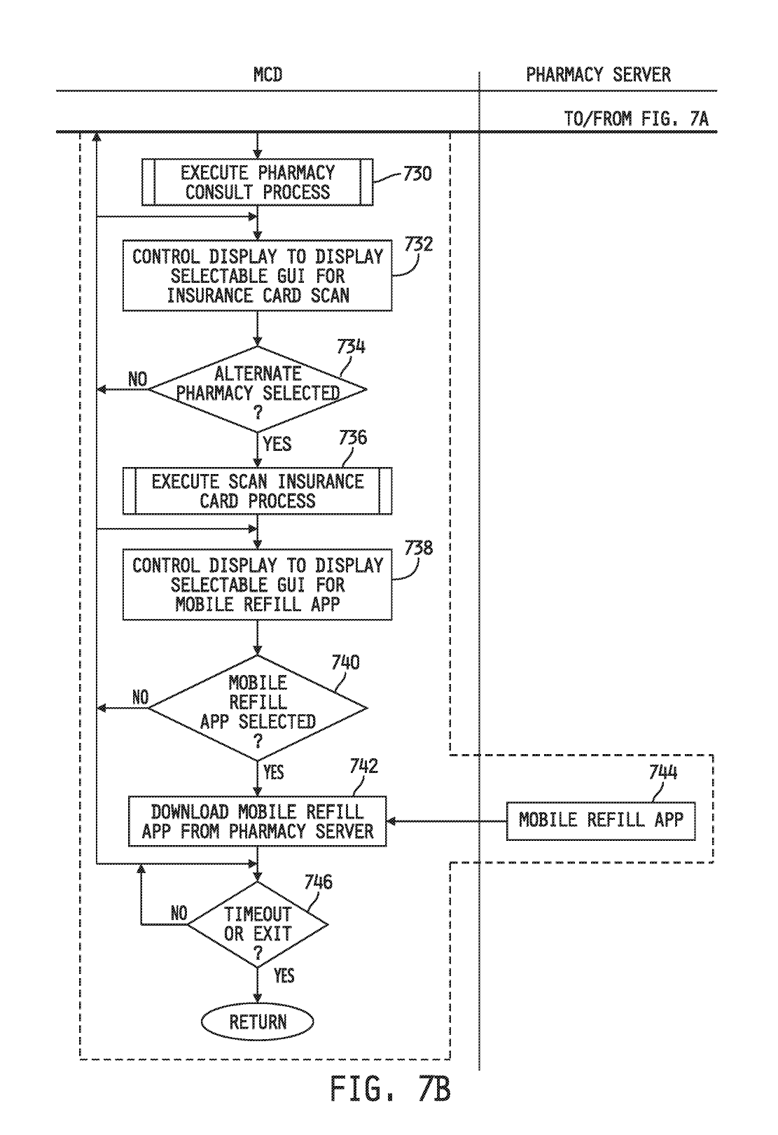

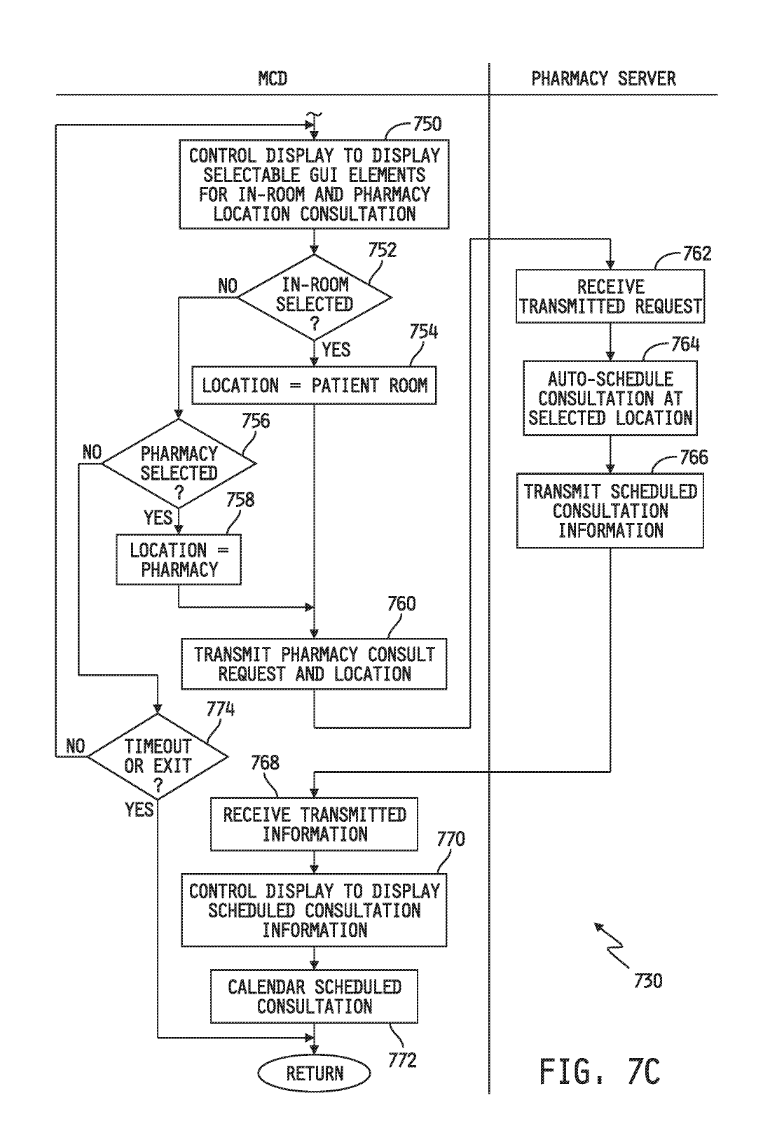

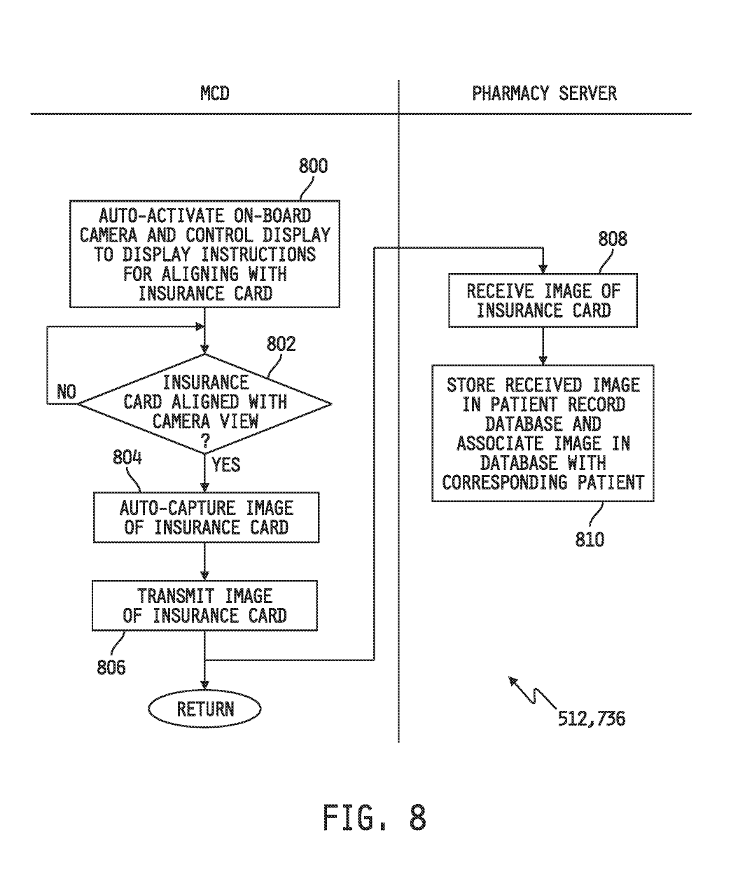

The schedule discharge medications module 336 is illustratively operable to manage obtaining and filling of patient's post-discharge medical prescriptions. In some embodiments, the schedule discharge medications module 336 is further operable to manage and control scheduling of pharmacy consulting services offered to patients and/or to authorized caregivers of patients. In some embodiments, the schedule discharge medications module 336 is further operable to manage and control scanning of patient insurance cards. In some embodiments, the schedule discharge medications module 336 is further operable to manage and control downloading of a mobile refill application to MCDs 80₁-80_{M} and/or to caregiver computers 90₁-90_{N}. Example embodiments of processes executed by the schedule discharge medications module 336 are illustrated in FIGS. 7A-7C and 8, and such processes will be described in detail hereinafter.

The scan insurance card management module 338 is illustratively operable to manage and control scanning of patient insurance cards using a camera 220 on-board a mobile communication device 80₁-80_{M} and/or by using a scanning device 268 connected to a caregiver computer 90₁-90_{N}. An example embodiment of a process executed by the scan insurance card management module 338 is illustrated in FIG. 8, and such a process will be described in detail hereinafter.

The diagnosis information management module 340 is illustratively operable to manage and control providing information to MCDs 80₁-80_{M} of patients and/or their authorized caregivers, and/or to computers 90₁-90_{N} of patient's authorized caregivers, relating to one or more patient diagnosis and/or patient medical condition. An example embodiment of a process executed by the diagnosis information management module 340 is illustrated in FIG. 9, and such a process will be described in detail hereinafter.

The web-based interface module 342 is illustratively operable to manage and control various web-based interfaces for viewing on a display 218 of an MCD 80₁-80_{M} and/or on a display 266 of a caregiver computer 90₁-90_{N}. The mobile prescription refill application module 344 illustratively has stored therein a mobile prescription refill application for download to MCDs 80₁-80_{M} of patients and/or their authorized caregivers, and/or to computers 90₁-90_{N} of patient's authorized caregivers, upon request, and is illustratively operable to control and manage such downloading processes.

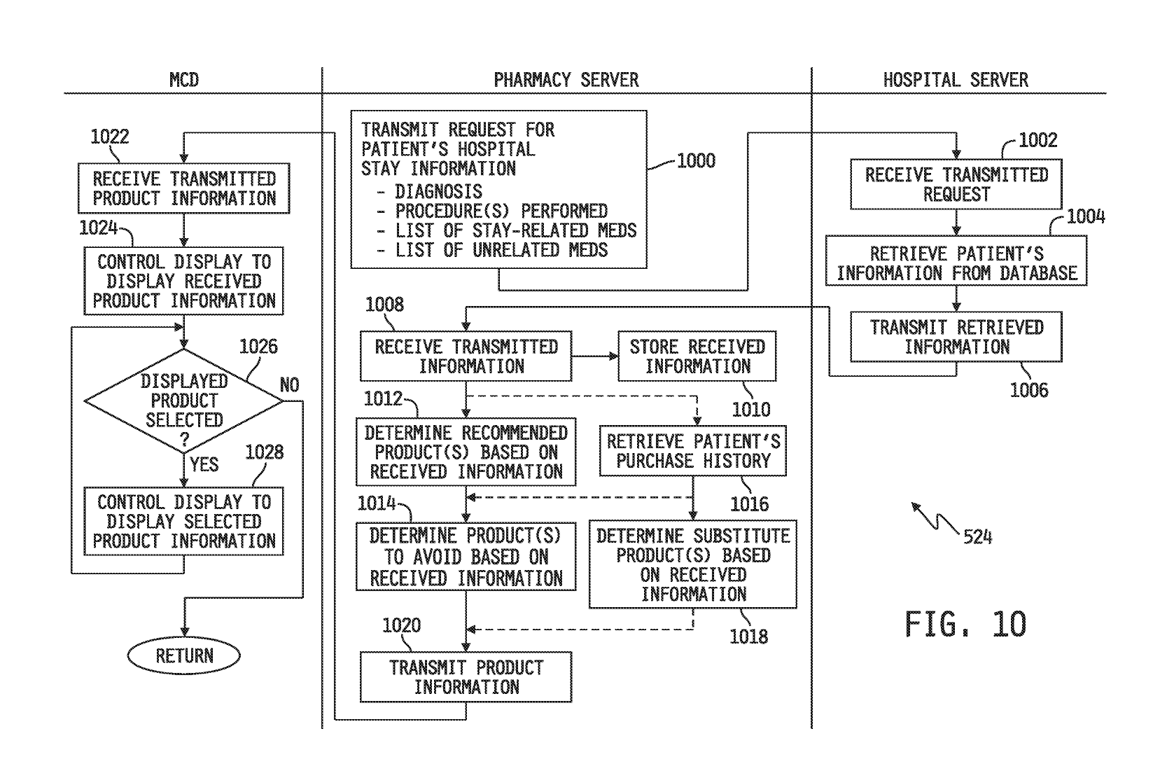

The product recommendation, avoidance and/or substation module 346 is illustratively operable upon patient discharge from a hospital following a hospital stay to obtain the patient's hospital stay-related information and determine, based thereon, one or more products to recommend to the patient, one or more products the patient should avoid and, in embodiments in which the patient is a customer-member of an EMS program as described above, one or more products the patient should consider substituting for one or more corresponding products typically purchased by the patient. Example embodiments of a process executed by the product recommendation, avoidance and/or substation module 346 is illustrated in FIG. 10 and will be described in detail hereinafter.

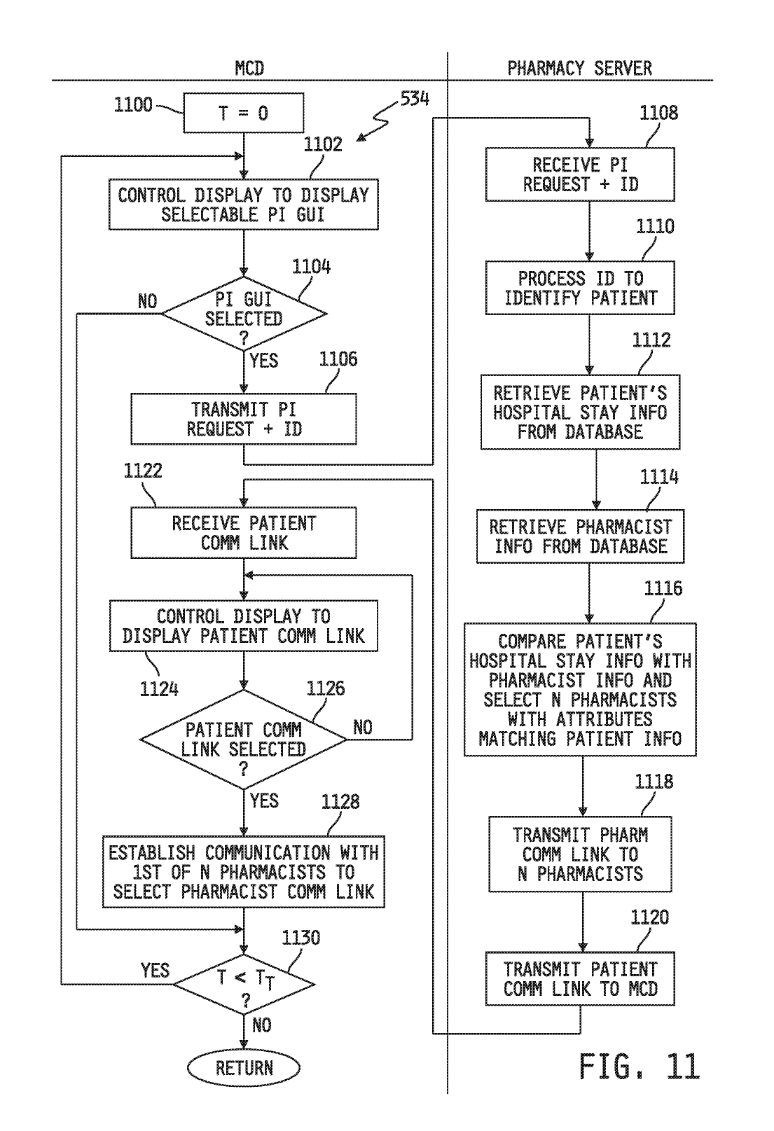

The pharmacist inquiry module 348 is illustratively operable, for at least a time period following a hospital stay by a patient (which time period may, in some embodiments, vary depending upon one or more factors relating to the hospital stay), provide for and facilitate direct patient contact and communication with a pharmacist of one of the retail pharmacies 24. An example embodiment of a process executed by the pharmacist inquiry module 348 is illustrated in FIG. 11 and will be described in detail hereinafter.

Referring now to FIG. 4, a simplified flow diagram is shown of a process 400 for recognizing and identifying mobile communication devices 80₁-80_{M} upon entry to/exit from the hospital 12, and to execute a process for establishing consent to enable a hospital stay mode or application of the pharmacy application 206 if stored in the memory 206 thereof and to share patient medical records between the pharmacy server 60 and the hospital server 14. Upon enablement of the hospital stay mode or application, an MCD 80₁-80_{M} of a patient admitted to the hospital 12, an MCDs 80₁-80_{M} of one or more authorized caregivers of a patient admitted to the hospital 12 and/or a computer(s) 90₁-90_{N} of one or more authorized caregivers of a patient admitted to the hospital 12 may execute the hospital stay mode or application to access a number of pharmacy-related services offered by the retail pharmacy enterprise or general retail enterprise via the pharmacy server 60.

As indicated by the framework of the process 400 illustrated in FIG. 4, a portion of the process 400, i.e., the portion to the left of the left-most vertical line and centered under the heading “MCD,” illustratively represents one or more software applications executed by the processor 200 of a patient's (or patient's authorized caregiver's) mobile communication device 80. The process steps of this portion of the process 400 will thus be described below for purposes of this disclosure as being executed by the processor 200 of the a mobile communication device 80. It will be understood that some of the steps of this portion of the process 400, e.g., steps 412-430 and 450, may alternatively or additionally be executed by a computer 90₁-90_{N} of an authorized caregiver of the patient. Another portion of the process 400, i.e., the portion between the left-most vertical line and the next vertical line to the right of the left-most vertical line in FIG. 4, and centered under the heading “Wireless Signal Receiver/Transmitter,” illustratively represents activities executed by one of the wireless signal broadcasting devices, e.g., beacons, 54, in embodiments which include such devices.

Yet another portion of the process 400, i.e., the portion between the vertical line to the right of the left-most vertical line and the rightmost vertical line in FIG. 4, and centered under the heading “Pharmacy Server,” illustratively represents one or more software applications executed by the processor 64 of pharmacy server 60. In one embodiment, this portion of the process 400 is stored in the Pharmacy Services Management Module 332 (see FIG. 3) in the form of instructions executable by the processor 64 of the pharmacy server 60. The process steps of this portion of the process 400 will be described below for purposes of this disclosure as being executed by the processor 64 of the pharmacy server 60. Still another portion of the process 400, i.e., the portion to the right of the right-most vertical line in FIG. 4, and centered under the heading “Hospital Server,” illustratively represents one or more software applications executed by the processor 26 of the hospital server 14. In one embodiment, this portion of the process 400 is stored in the memory 30 and/or data storage 32 of the hospital server 14 in the form of instructions executable by the processor 26 of the hospital server 14. The process steps of this portion of the process 400 will thus be described below for purposes of this disclosure as being executed by the processor 26 of the hospital server 14.

In the embodiment illustrated in FIG. 4, the process 400 begins at step 402, which may include any combination of steps 404-408, and which illustratively establishes recognition by the pharmacy server 60 of a mobile communication device 80₁-80_{M} carried by a patient and/or by an authorized caregiver of the patient when the patient and/or authorized caregiver of the patient enters the hospital 12 (an “entering MCD 80”). For purposes of this disclosure, an authorized caregiver of the patient may be or include any individual who has legal authority, e.g., by operation of a duly executed legal instrument or otherwise, to act as a caregiver of the patient and/or any individual to whom the patient has previously established an authorized caregiver status with the hospital server 14 and/or the pharmacy server 60. Examples of individuals who are or may be authorized caregivers include, but are not limited to, established physicians of patients, parents of minor patients, legal guardians of patients, persons having medial power of attorney for patients, and the like. Individuals may have pre-established caregiver status with the hospital server 14 and/or the pharmacy server 60 based on one or more previous admissions of a patient to the hospital 12 and/or based on one or more medications previously filled by one of the retail pharmacies 24₁-24_{L} and purchased/picked up by the individual on behalf of the patient. A patient may also establish authorized caregiver status for any individual as part of or after admission of the patient to the hospital by engaging in an authorized caregiver establishment process with the hospital 12. In any case, patients may have more than one authorized caregiver.

In embodiments which include the one or more beacons 54 as described hereinabove with respect to FIG. 1, step 402 illustratively includes detecting by the entering MCD 80 of wireless signals broadcast by one or more of the beacons 54 positioned at the entrance 25 to the hospital as the entering MCD 80 passes through the entrance 25, and wirelessly transmitting to the pharmacy server 60 all or some of the broadcast signal, or just the UID of the beacon 54 extracted from the broadcast signal, along with at least one identifier of the entering MCD 80, or individual carrying the entering MCD 80, previously stored on the entering MCD 80. An example identifier is an EMSID of the patient or caregiver which, of course, requires the patient to be a pre-established customer member of an enterprise membership service (EMS) hosted and managed by the pharmacy server 60. In one embodiment, the pharmacy application 206, if stored in the memory 206, illustratively stores and has access to the patient's or caregiver's EMSID, and in such embodiments this EMSID is transmitted as the identifier to the pharmacy server 60 along with the UID or wireless signal broadcast by the detected beacon 54. In other embodiments, such as in embodiments in which the retail pharmacy 24₁ is part of a larger, general retail enterprise which may host multiple enterprise membership services, an EMSID associated with a mobile application installed on the entering MCD 80 for any one of the multiple enterprise membership services may be transmitted by the entering MCD 80 as the identifier to the pharmacy server 60 along with the UID or wireless signal broadcast by the detected beacon 54.

Upon receipt by the pharmacy server 60 of the EMSID and UID (or wireless signal broadcast by the detected beacon 54) wirelessly transmitted by the entering MCD 80, the pharmacy server 60 is illustratively operable to process the UID (or to first process the wireless signal broadcast by the detected beacon 54 determine its UID) to determine the location of the beacon that broadcast the UID, and to process the EMSID to determine the identity of the individual associated with the entering MCD 80. If the UID corresponds to a beacon 54 positioned at an entrance 25 to the hospital 12, the pharmacy server 60 determines that the individual associated in the patient records database 304 with the entering MCD 80 has entered the hospital 12.

In embodiments which may not include the one or more beacons 54, the pharmacy application 206, and/or any other mobile application installed on the entering MCD 80 for any other of multiple enterprise membership services hosted and managed by the pharmacy server 60, may include a location services feature which, if previously consented to by the user of the MCD 80, allows tracking of the geographic location of the entering MCD 80. In such embodiments, the pharmacy/store location data may include geofence data for the hospital 12 which illustratively includes geographic coordinates defining a geofence about the hospital 12. An example of one such geofence 55 is illustrated in FIG. 1 as surrounding the perimeter of the hospital 12. In such embodiments, the pharmacy server 60 is illustratively operable at step 402 to monitor the location of the entering MCD 80 via the location services feature of pharmacy application 206, and/or other mobile application installed on the entering MCD 80 for any other of multiple enterprise membership services hosted and managed by the pharmacy server 60, and determine that the MCD 80 has entered the hospital 12 if the MCD 80 crosses the geofence 55. The pharmacy server 60 is then operable to process the EMSID associated with the pharmacy application or other mobile application installed on the entering MCD 80 for any other of multiple enterprise membership services hosted and managed by the pharmacy server 60 to determine that the individual associated in the patient records database 304 with the entering MCD 80 has entered the hospital 12.

Following step 402, the process 400 advances to step 410 where the process of recognizing entrance of the entering MCD 80 into the hospital 12 and recognition and identification of the user associated with the entering MCD 80 causes the pharmacy application 206 to wake up and launch, i.e., begin executing by the processor 200, if it is not already running on the entering MCD 80.

In embodiments which do not include the one or more beacons 54 or the geofence 55, the pharmacy application 206 may illustratively include a manual recognition feature whereby the user carrying the entering MCD 80 may manually launch the pharmacy application 206 at step 412 upon or after entering the hospital 12 and then select a link or selectable GUI element displayed on the display 218 as part of the application 206 which guides the user through one or more steps for transmitting notification to the pharmacy server 60 of the entrance of the entering MCD 80 into the hospital 12 and also transmitting the EMSID associated with the pharmacy application 206 or other mobile application installed on the entering MCD 80 for any other of multiple enterprise membership services hosted and managed by the pharmacy server 60 so that the pharmacy server 60 determines that the individual associated in the patient records database 304 with the entering MCD 80 has entered the hospital 12.

In still other embodiments in which the memory 204 of the entering MCD 80 does not have the pharmacy application 206 stored therein, one or more scannable codes, e.g., QR codes or other scannable codes, may be posted in and around the hospital 12, and the user of the entering MCD 80 may scan any such code to begin an automatic process, managed and controlled by the pharmacy server 60, to download the pharmacy application 206 to the entering MCD 80. The user of the entering MCD 80 can thereafter execute step 212 as described above to cause the pharmacy server 60 to determine that the individual associated in the patient records database 304 with the entering MCD 80 has entered the hospital 12.

In some alternate embodiments, the pharmacy application 206 may not be provided to and/or executed by the MCD 80, but rather the pharmacy application 206 may reside on the pharmacy server 60 and the pharmacy server 60 may be operable at step 414 to provide the various MCDs 80₁-80_{M} with access to the pharmacy application 206 via control and management of one of the web-based interfaces 342.

In any case, the process 400 advances from step 410 or 412, and/or as part of step 414, to step 416 where the processor 200 (or the processor 64) controls the display 218 of the entering MCD 80 to display a message and a selectable GUI element offering the patient or the authorized caregiver of the patient a “hospital stay” mode of the pharmacy application 206. In such embodiments, by selecting the displayed GUI element, the user of the entering MCD 80 begins a process to unlock or enable a so-called hospital stay operating mode of the pharmacy application 206 which will remain operable for at least the duration of the patient's stay at the hospital, i.e., at least until the patient is discharged from the hospital 12. In other embodiments, selecting the displayed GUI element may begin a process of downloading or gaining access to a web-based interface version of a hospital stay application that is separate from the pharmacy application. In any case, the process 400 advances from step 416 to step 418 where the processor 200 (or the processor 64) is operable to determine whether the displayed GUI element has been selected. If so, the process 400 advances to step 422, and otherwise the process 400 terminates at step 420.

At step 422, the processor 200 (or the processor 64) is operable to control the display 218 to display a selectable GUI element for consenting to share the patient's medical records between the pharmacy server 60 and the hospital server 14. If selected, the patient (or the patient's caregiver) consents to allow the hospital server 14 to share the patient's medical records with the pharmacy server 60 and to allow the pharmacy server 60 to share patient records with the hospital server 14. If, at step 424, the processor 200 (or the processor 64) determines that the display GUI element has been selected, the process 400 advances to step 426. Otherwise, the process 400 advances to step 452 which is a manually-conducted process in which the patient and/or one or more of the patient's caregivers provides the patient's medical record information to the pharmacy server 60.

At step 426, the processor 200 (or the processor 64) is operable to control the display 218 to display one or more selectable GUI elements for consenting to allow all pre-established caregivers to have access to a mirror of the patient's hospital stay mode of the pharmacy application 206 or hospital stay application. Thereafter at step 428 the processor 200 (or the processor 64) is operable to determine whether the consent GUI element has been selected. If so, the process 400 advances to step 430, and if not the process 400 advances to step 432 where the processor 200 (or the processor 64) is operable to control the display 218 to display a list of pre-established caregivers of the patient for selection of one or a subset thereof to have access to the mirror of the patient's hospital stay mode or application and/or to display one or more fields to allow authorization of one or more additional or alternate caregivers to have access to the mirror of the patient's hospital stay mode or application. In any case, in embodiments of the process 400 executed by the processor 200, the processor 200 is operable at step 430 to control the communication circuitry 212 to transmit to the pharmacy server 60 at least one identifier of the patient, an identifier of the selection at step 418 to receive access to the hospital stay mode or application, an identifier of the consent at step 424 to share the patient's medical records between the pharmacy server 60 and the hospital server 14, and at least one identifier of caregivers authorized to have access to a mirror of the patient's hospital stay mode or application. In embodiments of the process 400 executed by the processor 200, the process advances from step 430 to step 450 where the processor 200 is operable to execute the hospital stay mode of the pharmacy application 206 or the hospital stay application separate from the pharmacy application 206.

At step 434, the pharmacy processor 64 is operable to receive the information transmitted by the entering MCD 80 at step 430 in embodiments in which the processor 200 is operable to execute steps 416-432 of the process 400, or to receive the information selected at steps 418, 424 and 428 of the process 400 in embodiments in which the processor 64 of the pharmacy server 60 is operable to execute steps 416-432. Thereafter at step 436, the processor 64 is operable to control the communication circuitry 72 to transmit the patient consent, patient identifier and the at least one identifier of authorized caregivers to the hospital server 14. Illustratively, the information transmitted at step 436 is encrypted or tokenized to ensure security of the transmitted information.

At step 438, the information transmitted by the pharmacy server 60 is received by the hospital server 14, and thereafter at step 440 the processor 26 of the hospital server 14 is operable to process the received information and grant access by the pharmacy server 60 to the identified patient's medical records stored in the hospital server's database 30 and/or 32. Illustratively, the processor 26 is operable to execute step 440 by generating one or more unique access codes associated with the identified patient's stored medical records which is to be subsequently used by the pharmacy server 60 to gain access to the identified patient's stored medical records. Following step 440, the process 400 advances to step 442 where the processor 26 of the hospital server 14 is operable to control the communication circuitry 34 to transmit to the pharmacy server 60 the one or more unique access codes. The communication circuitry 72 of the pharmacy server 60 receives the transmitted one or more unique access codes at step 444. Thereafter at steps 446 and 448, and as needed, the pharmacy server 60 is operable to access the patient's medical records stored in the hospital server 14 using the one or more unique access codes, and the hospital server 14 is likewise operable to access the patient records stored in the pharmacy server 60 using the same or other unique access codes.

Referring now to FIG. 5A, a simplified flow diagram is shown depicting an embodiment of the hospital stay mode or application executed at step 450 of the process 400 illustrated in FIG. 4. In some embodiments, the hospital stay mode or application 450 is provided in the form of one particular operating mode of a pharmacy application executable or being executed by the processor 200 of the mobile communication device 80 of a patient and/or of one or more of the patient's caregivers, and/or by the processor 250 of a computer 90 owned and/or accessed by one or more of the patient's caregivers. In other embodiments, the hospital stay mode or application 450 may be provided in the form of one or more stand-alone applications executable by the processor 200 of the mobile communication device 80 of a patient and/or of one or more of the patient's caregivers, and/or by the processor 250 of a computer 90 owned and/or accessed by one or more of the patient's caregivers. In still other embodiments, the hospital stay mode or application 450 may be provided in the form of web-based interface executed by the processor 64 of the pharmacy server 60 and accessible by the mobile communication device 80 of a patient and/or of one or more of the patient's caregivers, and/or by a computer 90 owned and/or accessed by one or more of the patient's caregivers, via the network 62 or other secure network. The process steps of the hospital stay mode or application 450 will be described below for purposes of this disclosure as being executed by the processor 200 of the patient's (or one of the patient's caregiver's) mobile communication device 80, although it will be understood that the hospital stay mode or application 450 may alternatively be executed by one or more other processors of one or more other devices, computers, systems or servers illustrated and described herein, wherein the results of any such alternate execution of the mode or application 450 may be displayed to the patient and/or to one or more of the patient's caregivers via one or more displays of any such one or more other devices, computers, systems or servers and/or wherein input to the mode or application 450 required by a patient and/or one or more of the patient's caregivers may be accomplished via one or more conventional input devices of any such one or more other devices, computers, systems or servers.

The process 450 illustratively begins at step 500 where the processor 200 is operable to control the display 218 of the mobile communication device 80 to display a plurality of GUI elements each being individually selectable by a user (e.g., patient or patient's caregiver) via conventional techniques, e.g., touch-screen, button or key, track ball or pad or the like. Each selectable GUI element illustrative corresponds to a different selectable feature of the mode or application 450 that is available to the patient or patient's caregiver. Examples of such selectable features may illustratively include, but are not limited to, any one or more of a Maps feature, a Schedule Discharge Medications feature, a Scan Insurance Card feature and a Diagnosis Information feature. It will be understood that the mode or application 450 may alternatively include additional, fewer and/or different features than those just listed by example, and any such different and/or additional features are intended to fall within the scope of this disclosure.

The process 450 illustratively advances from step 500 to step 502 where the processor 200 is operable to determine whether the Maps feature has been selected. If so, the process 450 advances to step 504 where the processor 200 is operable to execute a Maps process. An example embodiment of the Maps process executed at step 504 is illustrated in FIG. 6 and will be described in detail hereinafter. If, at step 502, the processor 200 determines that the Maps feature has not been selected, the process 450 advances to step 506 where the processor 200 is operable to determine whether the Schedule Discharge Medications feature has been selected. If so, the process 450 advances to step 508 where the processor 200 is operable to execute a Schedule Discharge Medications process. An example embodiment of the Schedule Discharge Medications process executed at step 508 is illustrated in FIGS. 7A-7C and will be described in detail hereinafter.

If, at step 506, the processor 200 determines that the Schedule Discharge Medications feature has not been selected, the process 450 advances to step 510 where the processor 200 is operable to determine whether the Scan Insurance Card feature has been selected. If so, the process 450 advances to step 512 where the processor 200 is operable to execute a scan Insurance Card process. An example embodiment of the Scan Insurance Card process executed at step 512 is illustrated in FIG. 8 and will be described in detail hereinafter. If, at step 510, the processor 200 determines that the Scan Insurance Card feature has not been selected, the process 450 advances to step 514 where the processor 200 is operable to determine whether the Diagnosis Information feature has been selected. If so, the process 450 advances to step 516 where the processor 200 is operable to execute a Diagnosis Information process. An example embodiment of the Diagnosis Information process executed at step 516 is illustrated in FIG. 9 and will be described in detail hereinafter. Following execution of step 516, the process 450 illustratively loops back to step 500.

It will be understood that the order of execution of the pairs of steps 502-504, 506-508, 510-512 and 514-516 may be altered such that these pairs of steps may be executed in any desired order or sequence. Alternatively still, the process 450 may be modified such that the process 500 advances from step 500 simultaneously to each of steps 502, 506, 510 and 514 to monitor user selection of the various features displayed at step 500.

As illustrated in FIG. 5A, the processor 200 also executes step 518 in parallel with step 500. At step 518, the processor 200 is operable to determine whether the mobile communication device (MCD) 80 executing the process 450 has left the hospital 12. Illustratively, the processor 200 is operable to execute step 518 by engaging in one of more of the processes of step 402 illustrated in FIG. 4 and described in detail hereinabove. If the processor 200 determines at step 518 that the MCD 80 has left the hospital, the process 450 advances to step 520 where the processor 200 is operable to execute a process for determining whether the patient with which the MCD 80 is associated has been discharged from the hospital 12, and otherwise the process 450 loops back to the beginning of step 518. An example embodiment of the Patient Discharge Status process executed at step 520 is illustrated in FIG. 5B and will be described in detail hereinafter. Following execution of step 520, the process 450 advances to step 522 where the processor 200 is operable to determine whether, based on information provided by the Patient Discharge Status process executed at step 520, the patient with which the MCD 80 is associated has been discharged from the hospital 12. If so, the process 450 advances to step 524, and otherwise the process 450 loops back to the beginning of step 518.

If, at step 522, the processor 200 determines that the patient with which the MCD 80 is associated has been discharged from the hospital 12, the process 450 illustratively advances to step 524 where the processor 200 is illustratively operable to execute a hospital stay-based product recommendation, avoidance and/or substitution process 524. An example embodiment of such a process 524 is illustrated in FIG. 10, and will be described in detail hereinafter.

Following step 524, the process 450 advances to step 526 where the processor 200 is operable to control the display 218 to display a selectable GUI element for product/service order/pickup (e.g., curbside pickup) at a retail store affiliated with the retail pharmacy 24. If the processor 200 thereafter determines at step 528 that the GUI element displayed at step 526 is selected, the processor 200 is illustratively operable at step 530 to control the display 218 to display a selectable link to an item order/curb-side pickup application (or web interface hosted by the pharmacy server 60). Selection of the displayed link illustratively starts a process of downloading an item order/curb-side pickup application that will be executable by the processor 200 or causes the processor 200 to link to a web-based item order/curb-side pickup interface hosted by the pharmacy server 60. In some embodiments, such an application or web-based interface may be configured to display or otherwise make visually available one or more recommended products identified by the process 524, one or more products identified by the process 524 as products to avoid and/or one or more products identified by the process 524 as potential substitutes for corresponding products typically purchased by the patient or patient's authorized caregiver. In any case, the patient and/or authorized caregiver can access the application or engage the web-based interface to order items from the retail store affiliated with the retail pharmacy 24 for curb-side pickup after leaving the hospital 12 following discharge of the patient. Such items may be or include, for example, but are not limited to, food items, beverage items, clothing items, footwear, pet-related items, seasonal items, kitchen items, houseware items, electronic items, gardening items, hardware items, automotive-related items, tools and/or sporting goods. It will be understood that in some embodiments one or more of steps 524-530 may be optional, and one or more such steps may therefore be omitted in other embodiments

Following step 530 or the “No” branch of step 528 in embodiments which include steps 524-530, or following the “Yes” branch of step 522 in embodiments which do not include steps 524-530, the process 450 advances to step 532 where the processor 200 is operable to disable the hospital stay mode or application 450 being executed by the processor 200. In embodiments in which the hospital stay process 450 is a single-stay operating mode of a more general pharmacy application or other such application running on the MCD 80, the processor 200 is illustratively operable to execute step 532 by disabling operation of the hospital stay mode. In embodiments in which the hospital stay process 450 is a stand-alone, single-stay application being executed by the processor 200, the processor 200 is illustratively operable to execute step 532 by disabling execution of the process 450 unless and until the patient is again admitted or re-admitted to the hospital 12. In either case, the processor 200 is illustratively operable to execute step 532 by disabling the hospital stay mode or application after a predetermined time period elapses since determining at step 522 that the patient has been discharged from the hospital 12. The predetermined time period after which the hospital stay mode or application is disabled may illustratively vary by application, and may be as short as 1-2 seconds or as long as several days.

In some embodiments, the process 450 may also advance from step 530, and also from the NO branch of step 528, to step 534 where the processor 200 is operable to execute, for at least a time period following discharge of the patient, a pharmacist inquiry (PI) process. An example embodiment of the process 534 is illustrated in FIG. 11 and will be described in detail hereinafter.

As described above, the MCD 80 executing the process 450 may be a mobile communication device 80 carried by the patient or may be a mobile communication device 80 carried by an authorized caregiver of the patient. The MCD 80 detected as leaving the hospital at step 518 may thus be the patient's MCD 80 or may by the MCD 80 of an authorized caregiver of the patient, and in this regard the “patient with which the MCD 80 is associated” may accordingly be the user of the MCD 80 or may be a patient under the authorized care of the user of the MCD 80. Whereas patients generally may not or do not leave the hospital 12 after admission and prior to discharge, authorized caregivers of the patient may typically come and go as desired. Thus, for purposes of determining whether to disable operation of the hospital stay mode or application 450, steps 518-522 operate to determine whether a patient has been discharged from the hospital after determining that an MCD 80 associated with the patient has left the hospital 12. If the patient has not yet been discharged, then the hospital stay mode or application continues to be executed by the processor 200. Otherwise, the hospital stay mode or application is disabled after a predetermined time period has elapsed since making this determination. This feature allows authorized caregivers of the patient to come and go as desired without losing access to the hospital stay mode or application.

Referring now to FIG. 5B, a simplified flow diagram is shown depicting an embodiment of the patient discharge status process executed at step 520 of the hospital stay mode or application 450 illustrated in FIG. 5A. As indicated by the framework of the process 520 illustrated in FIG. 5B, a portion of the process 520, i.e., the portion to the left of the left-most vertical line and centered under the heading “MCD,” illustratively represents one or more software applications executed by the processor 200 of a patient's (or patient's caregiver's) mobile communication device 80. The process steps of this portion of the process 520 will thus be described below for purposes of this disclosure as being executed by the processor 200 of the a mobile communication device 80. Another portion of the process 520, i.e., the portion between the left-most vertical line and the rightmost vertical line in FIG. 5B, and centered under the heading “Pharmacy Server,” illustratively represents one or more software applications executed by the processor 64 of pharmacy server 60. In one embodiment, this portion of the process 520 is stored in the Pharmacy Services Management Module 332 (see FIG. 3) in the form of instructions executable by the processor 64 of the pharmacy server 60. The process steps of this portion of the process 520 will be described below for purposes of this disclosure as being executed by the processor 64 of the pharmacy server 60. Yet another portion of the process 520, i.e., the portion to the right of the right-most vertical line in FIG. 5B, and centered under the heading “Hospital Server,” illustratively represents one or more software applications executed by the processor 26 of the hospital server 14. In one embodiment, this portion of the process 520 is stored in the memory 30 and/or data storage 32 of the hospital server 14 in the form of instructions executable by the processor 26 of the hospital server 14. The process steps of this portion of the process 520 will thus be described below for purposes of this disclosure as being executed by the processor 26 of the hospital server 14.

In the embodiment illustrated in FIG. 5B, the process 520 illustratively begins at step 550 where the processor 200 of the MCD 80 executing the process 450, i.e., the MCD 80 detected at step 518 of the process 450 detected as having left the hospital 12, is operable to wirelessly transmit a request for patient discharge status, i.e., a request for information relating to whether the patient associated with the MCD 80 detected as having left the hospital has been discharged from the hospital 12. Thereafter at step 552, the pharmacy server 60 receives the transmitted request, e.g., via the communication circuitry 72, and at step 554 the processor 64 is operable to likewise transmit a request for the patient discharge status to the hospital server 14 via the network 62. Illustratively, the patient discharge status request transmitted by the MCD 80 includes an identifier of the patient in question. Alternatively or additionally, the processor 64 of the pharmacy server 60 may be operable at step 554 to determine the identity of the patient via information received from the MCD 80 at step 552, and in any case the patient discharge request transmitted by the pharmacy server 60 illustratively includes an identifier of the patient in question.

The hospital server 14 receives the transmitted request at step 556, e.g., via the communication circuitry 34, and at step 558 the processor 26 of the hospital server 14 is operable to process the patient identifier to determine the identity of the patient, and to then determine whether the identified patient has been discharged from the hospital 12. If so, the hospital server 14 is operable to transmit to the pharmacy server 60 a “patient discharged” message, i.e., a message indicating that the patient in question has been discharged from the hospital 12. If, on the other hand, the processor 26 determines that the identified patient has not been discharged, the hospital server 14 is operable to transmit to the pharmacy server 60 a “patient not discharged” message, i.e., a message indicating that the patient in question has not been discharged from the hospital 12.

At step 564, the pharmacy server 60 receives the message transmitted by the hospital server 14 relating to the discharge status of the identified patient. Thereafter at step 566, the pharmacy server is operable to record the patient discharge status, i.e., whether the patient has or has not been discharged from the hospital 12, by storing the patient discharge status in the patient records portion 304 of the server database 302. At step 568, the pharmacy server 60 is then operable to transmit a message to the MCD 80 indicating the patient discharge status. The MCD 80 receives the transmitted message at step 570, and thereafter the process 520 returns to step 520 of the process 450 illustrated in FIG. 5A.

Referring now to FIG. 6, a simplified flow diagram is shown depicting an embodiment of the Maps process executed at step 504 of the hospital stay mode or application 450 illustrated in FIG. 5A. As indicated by the framework of the process 504 illustrated in FIG. 6, a portion of the process 504, i.e., the portion to the left of the vertical line and centered under the heading “MCD,” illustratively represents one or more software applications executed by the processor 200 of the mobile communication device 80 executing the process 450 of FIG. 5A. Alternatively or additionally, in embodiments in which the process 450 is being executed by a caregiver computer 90, this portion of the process 504 is likewise illustratively executed by the processor 250 of the caregiver computer 90. For purposes of brevity, however, the process steps of this portion of the process 504 will be described below as being executed by the processor 200 of the mobile communication device 80 executing the process 450.

Another portion of the process 504, i.e., the portion to the right of the vertical line in FIG. 6, and centered under the heading “Pharmacy Server,” illustratively represents one or more software applications executed by the processor 64 of pharmacy server 60. In one embodiment, this portion of the process 504 is illustratively executed in whole or in part by the Map Management Module 334 (see FIG. 3) in the form of instructions executable by the processor 64 of the pharmacy server 60. The process steps of this portion of the process 504 will be described below for purposes of this disclosure as being executed by the processor 64 of the pharmacy server 60.

In the embodiment illustrated in FIG. 6, the process 504 illustratively begins at step 600 where the processor 200 of the MCD 80 executing the process 450, i.e., the MCD 80 carried by a patient and/or carried by an authorized caregiver of the patient, is operable to control the display 218 to display a plurality of GUI elements, each for a different corresponding map option and each being manually selectable via conventional techniques, e.g., touch-screen, button or key, track ball or pad or the like. Each selectable GUI element illustratively corresponds to a different selectable map that is available to the patient and/or the patient's caregiver(s) for the purpose of guiding the patient and/or the patient's caregiver(s) to various locations within the hospital 12. In embodiments in which the process 504 is being executed by an MCD 80, each different selectable map illustratively includes one or more visual guidance features, e.g., visual route information, for guiding the patient and/or the patient's caregiver(s) from the current location of the MCD 80 to the location of the selected map, wherein the current location of the MCD 80 executing the process 450 within the hospital 12 is illustratively determined and tracked using conventional techniques, e.g., from location information contained in communications conducted by the MCD 80 via the hospital WiFi system 36. In embodiments in which the process 504 is being executed by a caregiver computer 90, on the other hand, each different selectable map may illustratively include visual guidance features for depicting route information from one or more locations specified by the caregiver to the location of the selected map. In any case, examples of map options available for selection at step 600 may illustratively include, but are not limited to, any of one or more maps showing route information from the current location of the MCD 80 executing the process 450, or from a location selected by a user of a caregiver computer 90, to the retail pharmacy 24, to the one of the patient rooms 16 assigned (or reassigned) to the patient, to one or more of the medical procedure rooms 18, to one or more of the offices 20, to the reception/check-in area 22, to the chapel 23, to a cafeteria 27 or other food/beverage acquisition area of the hospital, to the gift shop 29, or to the main (or alternate) entrance/exit 25 of the hospital 12. It will be understood that the process 504 may alternatively include additional, fewer and/or different map options than those just listed by example, and any such different and/or additional map options are intended to fall within the scope of this disclosure.

The process 504 illustratively advances from step 600 to step 602 where the processor 200 (or the processor 250) is operable to determine whether one of the displayed map option GUI elements has been selected. If so, the process 504 advances to step 604 where the processor 200 is operable to control the communication circuitry 212 to wirelessly transmit (or the processor 250 is operable to control the communication circuitry 262 to transmit) to the pharmacy server 60 the selected map option, and otherwise the process 504 loops back to step 600.

At step 606, the pharmacy server 60 receives the request transmitted at step 604, and at step 608 the processor 64 of the pharmacy server 60 is operable to copy the hospital map, e.g., the hospital map or pertinent portion thereof stored in the hospital maps portion 306 of the pharmacy server database 302, and to modify the copied map or pertinent portion thereof to show route guidance information, e.g., from the MCD 80 executing the process 504 to the selected map location or from a user-selected location within the hospital 12 to the selected map location. Thereafter at step 610, the processor 64 of the pharmacy server 60 is operable to enable the modified map (or modified pertinent portion of the copied map) for access by and display on the MCD 80 (or the caregiver computer 90), e.g., to enable the modified map for viewing via a conventional web-enabled interface accessible by the MCD 80 and/or caregiver computer 90.

Following step 604, and following execution by the pharmacy server 60 of steps 606-610, the processor 200 (or the processor 250) is operable at step 612 to access the enabled map via the network 62 or other secure network, e.g., via the hospital WiFi system 36, and to control the display 218 (or the display 266) to display the enabled map.

In some embodiments, the Maps process may additionally include mapping/route features for locations outside of the hospital 12, e.g., for the purpose of showing locations of and/or navigation features for nearby, affiliated retail pharmacies, nearby, affiliated retail stores or outlets, nearby churches or other houses of worship, nearby restaurants, nearby hotels, nearby laundry services, or the like. In such embodiments, the process 504 may illustratively include additional steps for providing such mapping/route features, and an example additional step 614 is illustrated in FIG. 6 for providing mapping/route features to nearby affiliated retail pharmacy/store locations. It will be understood that step 614 is illustrative of any such additional mapping/route features described in this paragraph, and that any modifications required at step 614 for implementing any such other mapping/route features would be well within the abilities of a computer programmer of ordinary skill in the art. It will further be understood that step 614 is optional, and is therefore illustrated in dashed-line representation in FIG. 6.

In the illustrated embodiment, step 614 illustratively begins at step 616 where the processor 200 of the MCD 80 (or the processor 250 of the caregiver computer 90) executing the step 614 is operable to control the display 218 to display a GUI element for showing affiliated, nearby retail pharmacy/store locations, wherein the GUI element is manually selectable via conventional techniques, e.g., touch-screen, button or key, track ball or pad or the like. Illustratively, the map selectable via the displayed GUI element may include one or more visual guidance features, e.g., visual route information, for guiding the patient and/or the patient's caregiver(s) from the location of the hospital 12 to the location of one or more nearby, affiliated retail pharmacies/stores. The process of step 614 illustratively advances from step 616 to step 618 where the processor 200 (or the processor 250) is operable to determine whether the displayed map option GUI element has been selected. If so, the process of step 614 advances to step 620 where the processor 200 is operable to control the communication circuitry 212 to wirelessly transmit (or the processor 250 is operable to control the communication circuitry 262 to transmit) to the pharmacy server 60 the request for an alternate retail pharmacy/store locations map, and otherwise the process 504 loops back to step 600.

At step 622, the pharmacy server 60 receives the request transmitted at step 620, and at step 624 the processor 64 of the pharmacy server 60 is operable to access affiliated retail pharmacy and/or affiliated retail store/outlet data, e.g., from the pharmacy/store location data portion 310 of the pharmacy server database 302, and to identify from this data the location(s) of one or more affiliated retail pharmacies and/or affiliated retail stores/outlets within a predefined or selectable distance (e.g., 1 mile, 5 miles, 10 miles, etc.) from the hospital 12. Thereafter at step 626, the processor 64 of the pharmacy server 60 is operable to enable a list for display of the pharmacy/store locations identified at step 624. Alternatively or additionally, the processor 64 of the pharmacy server 60 may be operable at step 628 to copy a street map, e.g., from pertinent street map information stored in the street maps portion 308 of the pharmacy server database 302 and/or from one or more external street map databases, and to modify the copied street to show route guidance information, e.g., from the hospital 12 to the selected map location. Thereafter at step 630, the processor 64 of the pharmacy server 60 is operable to enable the modified map for access by and display on the MCD 80 (or the caregiver computer 90), e.g., to enable the modified map for viewing via a conventional web-enabled interface accessible by the MCD 80 and/or caregiver computer 90.

Following step 620, and following execution by the pharmacy server 60 of steps 622-630, the processor 200 (or the processor 250) is operable at step 632 to access the enabled list and/or map via the network 62 or other secure network, e.g., via the hospital WiFi system 36, and to control the display 218 (or the display 266) to display the enabled list and/or map.

As further illustrated in FIG. 6, the processor 200 (or processor 250) also executes step 634 in parallel with step 600. At step 634, the processor 200 (or processor 250) is operable to determine whether a time period for manual input (a “timeout”) has expired or a manual user exit command has been detected or received by the processor 200 (or processor 250). If so, the process 504 illustrated in FIG. 6 is returned to step 504 of the process 450 illustrated in FIG. 5A, and otherwise the process 504 illustrated in FIG. 6 loops back to step 600.

Referring now to FIG. 7A, a simplified flow diagram is shown depicting an embodiment of the Schedule Discharge Medications process executed at step 508 of the hospital stay mode or application 450 illustrated in FIG. 5A. As indicated by the framework of the process 508 illustrated in FIG. 7A, a portion of the process 508, i.e., the portion to the left of the vertical line and centered under the heading “MCD,” illustratively represents one or more software applications executed by the processor 200 of the mobile communication device 80 executing the process 450 of FIG. 5A. Alternatively or additionally, in embodiments in which the process 450 is being executed by a caregiver computer 90, this portion of the process 508 is likewise illustratively executed by the processor 250 of the caregiver computer 90. For purposes of brevity, however, the process steps of this portion of the process 508 will be described below as being executed by the processor 200 of the mobile communication device 80 executing the process 450.

Another portion of the process 508, i.e., the portion to the right of the vertical line in FIG. 7A, and centered under the heading “Pharmacy Server,” illustratively represents one or more software applications executed by the processor 64 of pharmacy server 60. In one embodiment, this portion of the process 508 is illustratively executed in whole or in part by the Schedule Discharge Medications Management Module 336 (see FIG. 3) in the form of instructions executable by the processor 64 of the pharmacy server 60. The process steps of this portion of the process 508 will be described below for purposes of this disclosure as being executed by the processor 64 of the pharmacy server 60.

In the embodiment illustrated in FIG. 7A, the process 508 illustratively begins at step 700 where the processor 200 of the MCD 80 executing the process 450, i.e., the MCD 80 carried by a patient and/or carried by an authorized caregiver of the patient, (or the processor 250 of the caregiver computer 90) is operable to control the display 218 (or the display 266) to display a GUI element for establishing consent by the patient or by an authorized one of the patient's one or more caregivers to allow the retail pharmacy to access and fill the patient's post-discharge medical prescriptions, wherein the displayed GUI element is manually selectable via conventional techniques, e.g., touch-screen, button or key, track ball or pad or the like. Thereafter at step 702, the processor 200 (or the processor 250) is operable to determine whether the displayed consent GUI element has been manually selected. If so, the process 508 advances to step 704 and otherwise the process 508 terminates and is returned to step 508 of the process 450 illustrated in FIG. 5A.

At step 704, the processor 200 (or the processor 250) is operable to control the display 218 (or the display 266) to display at least two GUI elements for selecting whether to pick up the patient's post-discharge medications at the co-located retail pharmacy 24, i.e., the retail pharmacy 24 located within the hospital 12, or at an alternate pharmacy location, e.g., a retail pharmacy external to the hospital 12, wherein the displayed GUI elements are manually selectable via conventional techniques, e.g., touch-screen, button or key, track ball or pad or the like. Thereafter at step 706, the processor 200 (or the processor 250) is operable to determine which of the two displayed pharmacy GUI elements has been manually selected. If the co-located pharmacy GUI element has been selected, the process 508 advances to step 712 and otherwise the process 508 advances to step 708 where the processor 200 (or the processor 250) is operable to control the display 218 (or the display 266) to display a list and/or map of alternate pharmacy locations within a predefined or selectable distance from the hospital 12. It will be understood that in some locations of the hospital 12 there may be one or more nearby retail pharmacies affiliated with the retail pharmacy 24, and in such cases the processor 200 (or the processor 250) will be operable at step 708 to control the display 218 (or the display 266) to display a list and/or map identifying and/or showing the locations of such retail pharmacies relative to the hospital 12. In other locations of the hospital 12, however, there may not be any nearby retail pharmacies affiliated with the retail pharmacy 24, and in such cases the processor 200 (or the processor 250) is illustratively operable at step 708 to control the display 218 (or the display 266) to display a list and/or map identifying and/or showing the locations of one or more retail pharmacies that is/are not part of or affiliated with the retail pharmacy 12. In some embodiments, the processor 200 (or 250) is operable at step 708 to access, e.g., via the network 62 or other network, the pharmacy/store location data portion 301 and/or the street maps portion 308 of the pharmacy server database 302 and to generate the list and/or map using such information. In alternative embodiments, the processor 200 (or the processor 250) may transmit a suitable request to the pharmacy server 60 and the processor 64 of the pharmacy server may be operable to generate such a list and/or map and make the list and/or map available for viewing on the display 218 (or the display 266) via a web-accessible interface. In any case, the process 508 advances from step 708 to step 710 to determine whether an alternate retail pharmacy location displayed at step 708 has been selected. If so, the process 508 advances to step 712, and otherwise the process 508 loops back to step 708. Although not illustrated in FIG. 7A, it will be understood that the process 508 may further include one or more conventional steps for exiting the series of steps 706-710 upon expiration of a timeout period or upon detection of a manually selected exit, wherein such an exit from the series of steps 706-710 may cause the process 508 to return to step 508 of the process 450 illustrated in FIG. 5A or to advance to some other step within the process 508.

At step 712, the processor 200 (or the processor 250) is operable to control the communication circuitry 212 to wirelessly transmit to the pharmacy server 60 (or to control the communication circuitry 262 to transmit to the pharmacy server 60) a patient consent indicator and an identity of the selected pharmacy, wherein the patient consent indicator is or includes one or more messages and/or data parameters identifying the patient and also identifying the consent by the patient to allow the retail pharmacy to access the patient's post-discharge medical prescriptions, which consent was given by the patient at steps 700-702, and wherein the selected pharmacy is the co-located retail pharmacy or the alternate retail pharmacy outside of the hospital 12, which was selected by the patient at steps 706-710.

The process 508 advances from step 712 to step 714 where the pharmacy server 60 receives the information transmitted at step 712, and thereafter at step 716 the processor 64 of the pharmacy server 60 is operable to access a third-party Pharmacy Benefit Management (PBM) and/or Specialty Prescription Management (SPM) service used by the patient's physician or physicians to process post-discharge medical prescriptions prescribed thereby. An example of such a PBM and/or SPM service which may be used by the patient's physician or physicians includes, but is not limited to, Express Scripts®. In any case, the PBM and/or SPM service is illustratively a service provided by one of the third-party system 76, and the processor 64 of the pharmacy server 60 is illustratively operable to execute step 716 by controlling the communication circuitry 72 to establish communications with the one of the third-party systems 76 and to provide to the PBM and/or SPM service via the one of the third-party system 76 the patient consent identifier, e.g., appropriately encrypted or otherwise securely protected. Upon receipt of the patient consent identifier, the PBM and/or SPM service is operable to process the patient identifier and provide access by the pharmacy server 60 to the patient's post-discharge medical prescriptions, e.g., by providing to the pharmacy server 60 one or more secure, e.g., encrypted or otherwise tokenized, access codes. Illustratively, the PBM and/or SPM service may be further operable to transmit one or more notifications to the pharmacy server 60 when such post-discharge medical prescriptions are ready and/or as each of multiple post-discharge medical prescriptions become ready, i.e., when received from the patient's physician or physicians and processed by the PBM and/or SPM for subsequent filling. In any case, the processor 64 of the pharmacy server 60 is illustratively operable at step 716 to obtain any such one or more post-discharge medical prescriptions, when ready, by establishing or continuing communications with the PBM and/or SPM service, e.g., via control of the communication circuitry 72 of the pharmacy server 60, and accessing the patient's post-discharge medical prescription(s) using the one or more access codes provided by the PMS and/or SPM service.

Following step 716, the processor 64 of the pharmacy server 60 is operable at step 718 to determine whether the retail pharmacy selected by the patient or one of the patient's authorized caregivers at steps 706-710 is a non-affiliated retail pharmacy. If so, the process 508 advances to step 720 where the processor 64 of the pharmacy server 60 is operable to transmit the prescription information to the non-affiliated pharmacy or to notify the non-affiliated pharmacy of the selection of the non-affiliated pharmacy by the patient or one of the patient's caregivers to fill the patient's post-discharge medications. If, at step 718, the processor 64 determines that the retail pharmacy selected by the patient or one of the patient's authorized caregivers is an affiliated retail pharmacy, e.g., the co-located retail pharmacy 24 or one of the retail pharmacy's locations near the hospital 12, the processor 64 is operable at step 722 to transmit the patient's post-discharge medical prescription(s) to the selected retail pharmacy location along with instructions to fill the prescription(s) at the selected retail pharmacy location for subsequent pickup by the patient or one of the patient's authorized caregivers. In some embodiments, step 722 may further include one or more steps for determining whether the selected retail pharmacy has the prescribed post-discharge medications in inventory, e.g., by accessing the medication inventory portion 316 of the pharmacy server database 302. In such embodiments, step 722 may further include one or more steps for ordering out-of-stock medication inventory and/or transferring out-of-stock medication from an affiliated retail pharmacy location to the selected retail pharmacy location when the processor 64 determines that the selected retail pharmacy does not have one or more of the post-discharge medications in inventory.

In some embodiments, the Schedule Discharge Medications process 508 may additionally include one or more additional services which relate to the patient's post-discharge medical prescriptions and/or post-discharge activities generally. In such embodiments, the process 508 may illustratively include additional steps for providing one or more such services, and an example additional step 724 is illustrated in FIG. 7A for providing a plurality of different additional services. It will be understood that step 724 is illustrative of such additional services, and that any modifications required at step 724 for implementing other additional services would be well within the abilities of a computer programmer of ordinary skill in the art. It will further be understood that step 724 and/or each of the various services included therein, is and are optional, and step 724 is therefore illustrated in dashed-line representation in FIG. 7A.

In the illustrated embodiment, step 724 illustratively begins at step 726 where the processor 200 of the MCD 80 (or the processor 250 of the caregiver computer 90) executing the step 724 is operable to control the display 218 (or to control the display 266) to display a GUI element for pharmacy consulting services to be provided by the retail pharmacy 24 or other affiliated retail pharmacy selected at steps 706-710, wherein the displayed GUI element is manually selectable via conventional techniques, e.g., touch-screen, button or key, track ball or pad or the like. Thereafter at step 728, the processor 200 (or the processor 250) is operable to determine whether the displayed pharmacy consulting GUI element has been manually selected. If so, the process 508 advances to step 730 where the processor 200 (or the processor 250) is operable to execute a pharmacy consulting process, and otherwise the process 508 advances to step 746 as illustrated in FIG. 7B. An example of an embodiment of the pharmacy consult process executed at step 730 is illustrated in FIG. 7C.

Referring now to FIG. 7C, a simplified flow diagram is shown depicting an embodiment of the Pharmacy Consult process executed at step 730 of the Schedule Discharge Medications process 508 illustrated in FIG. 7A. As indicated by the framework of the process 730 illustrated in FIG. 7C, a portion of the process 730, i.e., the portion to the left of the vertical line and centered under the heading “MCD,” illustratively represents one or more software applications executed by the processor 200 of the mobile communication device 80 executing the process 450 of FIG. 5A. Alternatively or additionally, in embodiments in which the process 450 is being executed by a caregiver computer 90, this portion of the process 730 is likewise illustratively executed by the processor 250 of the caregiver computer 90. For purposes of brevity, however, the process steps of this portion of the process 730 will be described below as being executed by the processor 200 of the mobile communication device 80 executing the process 450.

Another portion of the process 730, i.e., the portion to the right of the vertical line in FIG. 7C, and centered under the heading “Pharmacy Server,” illustratively represents one or more software applications executed by the processor 64 of pharmacy server 60. In one embodiment, this portion of the process 730 is illustratively executed in whole or in part by the Schedule Discharge Medications Management Module 336 (see FIG. 3) in the form of instructions executable by the processor 64 of the pharmacy server 60. The process steps of this portion of the process 730 will be described below for purposes of this disclosure as being executed by the processor 64 of the pharmacy server 60.

In the embodiment illustrated in FIG. 7C, the process 730 illustratively begins at step 750 where the processor 200 (or the processor 250) is operable to control the display 218 (or the display 266) to display to display at least two GUI elements for selecting whether to conduct the pharmacy consultation in the patient's room or at the selected retail pharmacy, wherein the displayed GUI elements are manually selectable via conventional techniques, e.g., touch-screen, button or key, track ball or pad or the like. Thereafter at step 752, the processor 200 (or the processor 250) is operable to determine whether the in-room pharmacy consultation GUI element has been selected. If so, the process 730 advances to step 754 where the processor 200 (or the processor 250) is operable to set a location identifier as the location of the patient's room. Illustratively, the processor 64 may be operable to identify the patient's room by retrieving this information from patient information stored on in the memory 204 or data storage 206 of the MCD 80 (or the memory 254 or data storage 256 of the caregiver computer 90) or by processing WiFi carrier information used to communicate wirelessly between the MCD 80 and the pharmacy server 60, or the like, or by transmitting a request for such information to the pharmacy server 60, wherein the processor 64 of the pharmacy server 60 may retrieve the requested information from the patient records portion 304 of the pharmacy server database 302 or from some other data storage location. If, at step 752, the processor 200 (or the processor 250) determines that the in-room pharmacy consultation GUI element has not been selected, the process 730 advances to step 756 where the processor 200 (or the processor 250) is operable to determine whether the pharmacy location consultation GUI element has been selected. If so, the process 730 advances to step 758 where the processor 200 (or the processor 250) is operable to set the location identifier as the location of the selected retail pharmacy. Otherwise, the process 730 advances to step 774 where the processor 200 (or the processor 250) is operable to determine whether a timeout time period has elapsed or a manually selected exit has been commanded. If not, the process 730 loops back to step 750, and if so the process 730 terminates and is returned to step 730 of the process 508 illustrated in FIG. 7A.

Following step 754 or step 758, the process 730 advances to step 760 where the processor 200 (or the processor 250) is operable to transmit to the pharmacy server 60 a pharmacy consult request and the selected pharmacy location identifier selected at step 754 or step 756. The pharmacy server 60 receives the transmitted information at step 762, and thereafter at step 764 the processor 64 of the pharmacy server 60 is operable to automatically schedule the pharmacy consultation at the selected location. The processor 64 is illustratively operable to execute step 764 by accessing pharmacy consultation scheduling information stored in the pharmacy consultation data portion 312 of the pharmacy database 302, and automatically scheduling an available time for conducting the selected in-room or pharmacy-location consultation. Alternatively, the processor 64 and the processor 200 (or the processor 250) may engage in an interactive process at step 764 to schedule an available pharmacy consultation time that is convenient for the patient.

In any case, the processor 64 is operable at step 766 to transmit the scheduled pharmacy consultation information, and at step 768 the MCD 80 (or the caregiver computer 90) receives the transmitted information. Thereafter at step 770, the processor 200 (or the processor 250) is operable to control the display 218 (or the display 266) to display the scheduled pharmacy consultation information including, for example, the scheduled pharmacy location and time. In some embodiments, the process 730 may further advance to step 772 where the processor 200 (or the processor 250) is operable to automatically calendar the scheduled pharmacy consultation in an appointment calendar application running on the patient's (or patient's caregiver's) MCD 80 and/or on the patient's caregiver's computer 90. Following step 772, the process 730 terminates and control is returned to step 730 of the process 508 illustrated in FIG. 7A.

Returning again to FIG. 7A, the process 508 advances from step 730 or from the “No” branch of step 728 to step 732 where the processor 200 of the MCD 80 (or the processor 250 of the caregiver computer 90) executing the step 724 is operable to control the display 218 (or to control the display 266) to display a GUI element for scanning a medical insurance card, wherein the displayed GUI element is manually selectable via conventional techniques, e.g., touch-screen, button or key, track ball or pad or the like. Thereafter at step 734, the processor 200 (or the processor 250) is operable to determine whether the displayed insurance card scan GUI element has been manually selected. If so, the process 508 advances to step 736 (see FIG. 7B) where the processor 200 (or the processor 250) is operable to execute an insurance card scanning process, and otherwise the process 508 advances to step 740 as illustrated in FIG. 7B. An example of an embodiment of the insurance card scanning process executed at step 736 is illustrated in FIG. 8, and will be described in detail hereinafter.

Referring now to FIG. 7B, the process 508 advances from step 736 or from the “No” branch of step 734 to step 738 where the processor 200 of the MCD 80 (or the processor 250 of the caregiver computer 90) executing the step 724 is operable to control the display 218 (or to control the display 266) to display a GUI element for a mobile prescription refill application, wherein the displayed GUI element is manually selectable via conventional techniques, e.g., touch-screen, button or key, track ball or pad or the like. Thereafter at step 740, the processor 200 (or the processor 250) is operable to determine whether the displayed mobile prescription refill application GUI element has been manually selected. If so, the process 508 advances to steps 742 and 744 where the processor 200 (or the processor 250) and the processor 64 of the pharmacy server 60 cooperate to download a mobile prescription refill application to the MCD 80 (or caregiver computer 90) from the mobile prescription refill application module 344 of the pharmacy services module 330 of FIG. 3. Once downloaded, the mobile prescription refill application may be operated on the patient's MCD 80, the MCD 80 of one or more authorized caregiver(s) of the patient and/or on the computer 90 of the patient and/or authorized caregiver of the patient to manage refills of one or more of the post-discharge medications prescribed by the patient's physician or physicians and/or to manage refills of any other recurring medications prescribed to the patient. In any case, the process 508 advances from step 742 to step 746.

It will be understood that while the various features of step 724 have been illustrated and described as being offered sequentially, the process 508 may alternatively be structure such that each of the features may be presented to, and be selectable by, the user in parallel. In FIGS. 7A and 7B, for example, the process 508 illustrated in step 724 may alternatively advance in parallel from step 712 to each of steps 726, 732, 738 and 742 as shown in FIGS. 7A and 7B.

Referring now to FIG. 8, a simplified flow diagram is shown depicting an embodiment of the Scan Insurance Card process executed at step 512 of the hospital stay mode or application 450 illustrated in FIG. 5A and optionally executed at step 736 of the process 508 illustrated in FIG. 7B. As indicated by the framework of the process 512 illustrated in FIG. 8, a portion of the process 512, i.e., the portion to the left of the vertical line and centered under the heading “MCD,” illustratively represents one or more software applications executed by the processor 200 of the mobile communication device 80 executing the process 450 of FIG. 5A. The process steps of this portion of the process 512 will thus be described below as being executed by the processor 200 of the mobile communication device 80 executing the process 450.

Another portion of the process 512, i.e., the portion to the right of the vertical line in FIG. 8, and centered under the heading “Pharmacy Server,” illustratively represents one or more software applications executed by the processor 64 of pharmacy server 60. In one embodiment, this portion of the process 512 is illustratively executed in whole or in part by the Scan Insurance Card Management Module 338 (see FIG. 3) in the form of instructions executable by the processor 64 of the pharmacy server 60. The process steps of this portion of the process 512 will be described below for purposes of this disclosure as being executed by the processor 64 of the pharmacy server 60.

In the embodiment illustrated in FIG. 8, the process 512 illustratively begins at step 800 where the processor 200 of the MCD 80 executing the process 450, i.e., the MCD 80 carried by a patient and/or carried by an authorized caregiver of the patient, is operable to automatically active the on-board camera 220 and to control the display 218 to display instructions for aligning the image viewed by the camera 220 with the patient's medical insurance card. Thereafter at step 802, the processor 200 is operable to determine whether the patient's medical insurance card is appropriately aligned with image viewed by the on-board camera 220, and if not the process loops back to step 802 until appropriate alignment is detected. When the processor 200 determines at step 802 that the patient's medical insurance card and the image viewed by the camera 220 are appropriately aligned with each other, the process 512 advances to step 804 where the processor 200 is operable to control the on-board camera 220 to automatically capture an image of the patient's medical insurance card. In some alternative embodiments, step 804 may be modified to require manually activated capture of the image by the camera 220. In any case, following step 804, the processor 200 is operable to control the communication circuitry 212 to wirelessly transmit the captured image of the patient's medical insurance card to the pharmacy server 60.

The pharmacy server 60 receives the captured image at step 808, and thereafter at step 810 the processor 64 of the pharmacy server 60 is operable to store the received image in the patient records portion 304 of the pharmacy server database 302 and associate the image in the patient records 304 with the corresponding patient. Thereafter, the retail pharmacy 24 or off-site affiliated retail pharmacy may access the image in order to access the patient's insurance information when filling and/or refilling post-discharge or other medical prescriptions for the patient. In any case, following step 806, the process 512 terminates and control is returned to step 512 of the process 450 illustrated in FIG. 5A.

Referring now to FIG. 9, a simplified flow diagram is shown depicting an embodiment of the Diagnosis Information process executed at step 516 of the hospital stay mode or application 450 illustrated in FIG. 5A. As indicated by the framework of the process 516 illustrated in FIG. 9, a portion of the process 516, i.e., the portion to the left of the vertical line and centered under the heading “MCD,” illustratively represents one or more software applications executed by the processor 200 of the mobile communication device 80 executing the process 450 of FIG. 5A. Alternatively or additionally, in embodiments in which the process 450 is being executed by a caregiver computer 90, this portion of the process 516 is likewise illustratively executed by the processor 250 of the caregiver computer 90. For purposes of brevity, however, the process steps of this portion of the process 516 will be described below as being executed by the processor 200 of the mobile communication device 80 executing the process 450.

Another portion of the process 516, i.e., the portion to the right of the vertical line in FIG. 8, and centered under the heading “Pharmacy Server,” illustratively represents one or more software applications executed by the processor 64 of pharmacy server 60. In one embodiment, this portion of the process 516 is illustratively executed in whole or in part by the Diagnosis Information Management Module 340 (see FIG. 3) in the form of instructions executable by the processor 64 of the pharmacy server 60. The process steps of this portion of the process 516 will be described below for purposes of this disclosure as being executed by the processor 64 of the pharmacy server 60.

In the embodiment illustrated in FIG. 9, the process 516 illustratively begins at step 900 where the processor 200 of the MCD 80 executing the process 450, i.e., the MCD 80 carried by a patient and/or carried by an authorized caregiver of the patient, and/or the processor 250 of a computer 90 of an authorized caregiver of the patient, is operable to transmit to the pharmacy server a request for information about one or more of the patient's diagnoses or medical conditions. In one embodiment, the process 516 is illustratively structured to allow requests for information about one diagnosis or medical condition at a time, although other embodiments are contemplated which provide for requests for information about multiple diagnoses and/or medical conditions. In any case, the transmitted request is received by the pharmacy server 60 at step 902, and thereafter at step 904 the processor 64 of the pharmacy server 60 is operable to access the patient's diagnosis/condition information, e.g., from the patient records portion 304 of the server database 302 or from the hospital server 14. Thereafter at step 906, the processor 64 is illustratively operable to access corresponding diagnosis or medical condition information, e.g., from the diagnosis and medical condition information portion 314 of the pharmacy server database 302, for at least one diagnosis or medical condition of the patient for which the patient has been admitted to the hospital 12. Thereafter at step 908, the processor 64 is operable to control the communication circuitry 72 to transmit to the MCD 80 (or the caregiver computer 90) some or all of the diagnosis or medical condition information obtained at step 906.

At step 910, the processor 200 of the MCD 80 (or the processor 250 of the caregiver computer 90) is operable to control the display 218 (or the display 266) to display the received diagnosis or medical condition information. In some embodiments, the process 516 may further include additional steps 912-918 via which the patient and/or authorized caregiver(s) may obtain additional, publicly available information about one or more diagnoses and/or medical conditions of the patient. In such embodiments, the process 516 illustratively advances to step 912 where the processor 200 (or the processor 250) is operable to control the display 218 (or the display 266) to display a GUI element for conducting an internet search (e.g., via the World Wide Web) for patient diagnosis and/or medical condition information, wherein the displayed GUI element is manually selectable via conventional techniques, e.g., touch-screen, button or key, track ball or pad or the like. Thereafter at step 914, the processor 200 (or the processor 250) is operable to determine whether the displayed GUI has been selected. If so, the process 516 advances to step 916, and otherwise the process 516 loops back to step 912.

At step 916, the processor 200 (or the processor 250) is illustratively operable to automatically enter the patient-requested diagnosis and/or medical information into a conventional internet search engine and to thereafter automatically control the internet search engine to conduct the search. In some alternative embodiments, the patient or caregiver may manually enter the patient diagnosis and/or medical condition information into the internet search engine and manually conduct the search in a conventional manner. In any case, the process 516 advances from step 916 to step 918 where the processor 200 (or the processor 250) is operable to control the display 218 (or the display 266) to display the search results. Thereafter, the process 516 terminates and control is returned to step 516 of the process 450 illustrated in FIG. 5A.

Referring now to FIG. 10, a simplified flow diagram is shown depicting an embodiment of the hospital stay-based product recommendation, avoidance and/or substitution process executed at step 524 of the hospital stay mode or application 450 illustrated in FIG. 5A. As indicated by the framework of the process 524 illustrated in FIG. 10, a portion of the process 524, i.e., the portion to the left of the left-most vertical line and centered under the heading “MCD,” illustratively represents one or more software applications executed by the processor 200 of a patient's (or patient's caregiver's) mobile communication device 80. The process steps of this portion of the process 524 will thus be described below for purposes of this disclosure as being executed by the processor 200 of the a mobile communication device 80. Another portion of the process 524, i.e., the portion between the left-most vertical line and the rightmost vertical line in FIG. 5B, and centered under the heading “Pharmacy Server,” illustratively represents one or more software applications executed by the processor 64 of pharmacy server 60. In one embodiment, this portion of the process 524 is stored in the Product Recommend, Avoid, Substitute Module 346 (see FIG. 3) in the form of instructions executable by the processor 64 of the pharmacy server 60. The process steps of this portion of the process 524 will be described below for purposes of this disclosure as being executed by the processor 64 of the pharmacy server 60. Yet another portion of the process 524, i.e., the portion to the right of the right-most vertical line in FIG. 5B, and centered under the heading “Hospital Server,” illustratively represents one or more software applications executed by the processor 26 of the hospital server 14. In one embodiment, this portion of the process 524 is stored in the memory 30 and/or data storage 32 of the hospital server 14 in the form of instructions executable by the processor 26 of the hospital server 14. The process steps of this portion of the process 524 will thus be described below for purposes of this disclosure as being executed by the processor 26 of the hospital server 14.

In the embodiment illustrated in FIG. 10, the process 524 illustratively begins at step 1000 where the processor 64 of the pharmacy server 60 is operable to control the communication circuitry 72 of the pharmacy server 60 to transmit to the hospital server 24 a request for the patient's (i.e., the patient detected at step 522 as discharged) hospital stay information. Such information may include, but should not be limited to, diagnosis information, i.e., one or more diagnoses of the patient that gave rise to the hospital stay from which the patient was just discharged, one or more medical procedures performed during the hospital stay, a list of hospital stay-related medications, e.g., medications administered to the patient during the hospital stay and/or medications prescribed, and/or over-the-counter medications recommended, to the patient to be administered following patient discharge, a list of unrelated medications, e.g., prescribed and/or over-the-counter medications being taken before and/or during, and/or to be administered after, patient discharge, some or all of the patient's medical history, patient allergies and triggers thereof, and the like.

At step 1002, the request transmitted at step 1000 is received by the communication circuitry 34 of the hospital server 24, and thereafter at step 1004 the processor 26 of the hospital server 24 is operable to retrieve the patent's information from the hospital server database 32. Thereafter at step 1006, the processor 26 of the hospital server 24 is operable to control the communication circuitry 34 to transmit the retrieved information to the pharmacy server 60, and at step 1008 the communication circuitry 72 of the pharmacy server 60 receives the transmitted information and provides the same to the processor 64. In the illustrated embodiment, the process just described of requesting and receiving by the pharmacy server 60 of a patient's hospital stay information is done so without the patient's consent. In other embodiments, the process 524 may include additional steps for requesting, receiving and providing by the pharmacy server 60 to the hospital server 24 of a patient's consent to provide such patient stay information, and examples of some such steps are illustrated by steps 700-716 of the process 508 illustrated in FIG. 7A.

In some embodiments, the process 524 advances from step 1008 to step 1010 where the processor 64 of the pharmacy server 60 is operable to store the received patient hospital stay information in the database 302, e.g., in the patient records portion 304 of the database 302. In other embodiments, step 1010 may be omitted. In any case, the process 524 illustratively advances from step 1008 to step 1012 where the processor 64 of the pharmacy server 60 is operable to determine one or more recommended products based on the received patient hospital stay information. The determination made at step 1012 may be made based on any one or combination of the patient diagnosis information, the information relating to the procedure(s) performed during the hospital stay, the list of stay-related medication(s), the list of unrelated medication(s), some or all of the patient's medical history and/or patient allergies and triggers thereof and/or any alternate or additional information relating to the patient's hospital stay. As one example, the list of stay-related medication(s) may be or include an antibiotic having as a common side effect an increase sensitivity to sunlight, and in this example the processor 64 may be operable at step 1012 to recommend a suitable sunscreen, a suitable lip balm, one or more suitable shade-inducing hats or caps and/or one or more articles of protective (e.g., high SPF value) clothing, handwear, footwear and/or headwear. As another example, the patient diagnosis information may be a broken bone, and in this example the processor 64 may be operable at step 1012 to recommend one or more suitable supplements such as vitamin D and/or E, or to recommend one or more food items high in such vitamins. As yet another example, the performed procedure information may identify a painful physical procedure for which no medications were prescribed, and in this example the processor 64 may be operable at step 1012 to recommend one or more over-the-counter medications such as aspirin or ibuprofen. As yet a further example, the patient diagnosis information may identify a diabetic condition and the list of stay-related medications may include insulin, and in this example the processor 64 may be operable at step 1012 to recommend one or more diabetic condition-related products such as weight scale, one or more suitable nutrition books, one or more food products, one or more exercise products, or the like. It will be understood that the foregoing examples are provided only by way of illustration and are not intended to be limiting in any way. Those skilled in the art will recognize other examples in which the processor 64 may be operable to recommend one or more products based on the received patient hospital stay information, and it will be understood that such other examples are contemplated by this disclosure.

Following step 1012, or following step 1008 in embodiments which do not include step 1012, the process 524 advances to step 1014 where the processor 64 of the pharmacy server 60 is operable to determine one or more products that the patient should avoid based on the received patient hospital stay information. The determination made at step 1014 may be made based on any one or combination of the patient diagnosis information, the information relating to the procedure(s) performed during the hospital stay, the list of stay-related medication(s), the list of unrelated medication(s), some or all of the patient's medical history and/or patient allergies and triggers thereof and/or any alternate or additional information relating to the patient's hospital stay. As one example, the list of stay-related medication(s) may be or include an antibiotic having as a common side effect an increased sensitivity to alcohol, and in this example the processor 64 may be operable at step 1014 to recommend that the patient avoid consumption of alcoholic products while taking the medication. As another example, the list of stay-related medication(s) may be or include a medication having an efficacy which may be inhibited by ingesting certain foods or certain quantities of certain foods, and in this example the processor 64 may be operable at step 1014 to recommend that the patient avoid consumption of such foods and/or consumption of large amounts of such foods. It will be understood that the foregoing examples are provided only by way of illustration and are not intended to be limiting in any way. Those skilled in the art will recognize other examples in which the processor 64 may be operable to recommend one or more products to avoid based on the received patient hospital stay information, and it will be understood that such other examples are contemplated by this disclosure.

In some embodiments in which the database 302 includes customer purchase histories 318, the process 524 may include a step 1016 in which the processor 64 of the pharmacy server 60 is operable to retrieve the patient's (or patient's authorized caregiver's) purchase history. In such embodiments, the patient's or authorized caregiver's purchase history may be used by the processor 64 to inform the product avoidance process carried out at step 1014. As one example, the patient's hospital stay information may identify a diagnosis, procedure, medication, medical history component and/or patient allergy for which a particular food, category of foods, beverage and/or category of beverage typically purchased by the patient or authorized caregiver is contraindicated, and in this example the processor 64 may be operable at step 1014 to recommend that the patient avoid consumption of such food, category of foods, beverage and/or category of beverage. It will be understood that the foregoing example is provided only by way of illustration and is not intended to be limiting in any way. Those skilled in the art will recognize other examples in which the processor 64 may be operable to recommend avoidance of one or more items typically purchased by the patient or authorized caregiver, and it will be understood that such other examples are contemplated by this disclosure.

In some embodiments in which the process 524 includes step 1016, the process 524 may further include step 1018 in which the processor 64 of the pharmacy server 60 is operable to determine one or more products that the patient or authorized caregiver typically purchases but should be substituted with another product because it contains one or more ingredients that is/are contraindicated by one or more aspects of the received patient hospital stay information. The determination made at step 1018 may be made based on any one or combination of the patient diagnosis information, the information relating to the procedure(s) performed during the hospital stay, the list of stay-related medication(s), the list of unrelated medication(s), some or all of the patient's medical history and/or patient allergies and triggers thereof and/or any alternate or additional information relating to the patient's hospital stay. As one example, the list of stay-related medication(s) may be or include an antibiotic having as a common side effect an increased sensitivity to sunlight and the patient's hospital stay information may note a patient allergy to an ingredient found in some sunscreen products previously purchased by the patient or authorized caregiver but not in others, and in this example the processor 64 may be operable at step 1018 to recommend that the patient or authorized caregiver substitute the previously purchased sunscreen product with a suitable sunscreen product that does not include the ingredient to which the patient is allergic. As another example, the patient's hospital stay information may note a patient sensitivity to an ingredient, e.g., gluten, found in some foods and a procedure may have been performed on the patient and/or a medication prescribed which may increase such sensitivity, and in this example the processor 64 may be operable at step 1018 to recommend that the patient or authorized caregiver at least temporarily substitute products typically purchased by the patient or authorized caregiver that include such an ingredient with one or more suggested products that do not. It will be understood that the foregoing examples are provided only by way of illustration and are not intended to be limiting in any way. Those skilled in the art will recognize other examples in which the processor 64 may be operable to recommend substitution of one or more items previously and/or typically purchased by the patient or authorized caregiver, and it will be understood that such other examples are contemplated by this disclosure.

Following any one or combination of steps 1012, 1014 and 1018, the processor 64 of the pharmacy server 60 is operable to control the communication circuitry 72 to transmit the determined product information, i.e., the one or more products recommended at step 1012, the one or more products to be avoided as determined at step 1014 and/or the one or more products to substitute for previously and/or typically purchased products as determined at step 1018, to the MCD 80. Thereafter at step 1022, the communication circuitry 212 of the MCD 80 (and/or the communication circuitry 262 of the caregiver computer 90) is operable to receive the transmitted product information and to provide the same to the processor 200 (or 250) thereof, and thereafter the process 524 advances to step 1024.

At step 1024, the processor 200 (or 250) is operable to control the display 218 (or 266) to display the received product information. Thereafter at step 1026, the processor 200 (or 250) is illustratively operable to determine whether any of the displayed products has been selected. If so, the process 524 illustratively advances to step 1028 and otherwise the process 524 illustratively returns to step 524 of the process 450 illustrated in FIG. 5A.

At step 1028, the processor 200 (or 250) is illustratively operable to control the display 218 (or 266) to display information related to the selected product. Example items that may be included in such information may include, but should not be limited to, one or more of an explanation of the recommendation, a duration of the recommendation, benefits received by following the recommendation, disadvantages of not following the recommendation, and the like.

Referring now to FIG. 11, a simplified flow diagram is shown depicting an embodiment of the pharmacist inquiry process executed at step 534 of the hospital stay mode or application 450 illustrated in FIG. 5A. As indicated by the framework of the process 534 illustrated in FIG. 11, a portion of the process 534, i.e., the portion to the left of the vertical line and centered under the heading “MCD,” illustratively represents one or more software applications executed by the processor 200 of the mobile communication device 80 executing the process 450 of FIG. 5A. Alternatively or additionally, in embodiments in which the process 450 is being executed by a caregiver computer 90, this portion of the process 534 is likewise illustratively executed by the processor 250 of the caregiver computer 90. For purposes of brevity, however, the process steps of this portion of the process 534 will be described below as being executed by the processor 200 of the mobile communication device 80 executing the process 450.

Another portion of the process 534, i.e., the portion to the right of the vertical line in FIG. 11, and centered under the heading “Pharmacy Server,” illustratively represents one or more software applications executed by the processor 64 of pharmacy server 60. In one embodiment, this portion of the process 534 is illustratively executed in whole or in part by the Pharmacist Inquiry Module 348 (see FIG. 3) in the form of instructions executable by the processor 64 of the pharmacy server 60. The process steps of this portion of the process 534 will be described below for purposes of this disclosure as being executed by the processor 64 of the pharmacy server 60.

In the embodiment illustrated in FIG. 11, the process 534 illustratively begins at step 1100 where the processor 200 of the MCD 80 executing the process 450, i.e., the MCD 80 carried by a patient and/or carried by an authorized caregiver of the patient, (or the processor 250 of the caregiver computer 90) is operable to set a timer, T, equal to zero or some other constant. Thereafter at step 1102, the processor 200 is operable to control the display 218 (or the display 266) to display a selectable GUI element for establishing live communication link with a pharmacist of one of the retail pharmacies 24. Thereafter at step 1104, the processor 200 is operable to determine whether the GUI displayed at step 1102 has been selected. If so, the process 534 advances to step 1106 and otherwise the process advances to step 1130. At step 1106, the processor 200 is operable to control the communication circuitry 212 to transmit to the pharmacist inquiry (PI) request and an identification (ID) of the patient (e.g., patient identifier, identification or cell phone number of the MCD, etc.) to the pharmacy server 60. Thereafter at step 1108, the communication circuitry 72 of the pharmacy server 60 receives the request and provides the same to the processor 64.

Following step 1108, the processor 64 is operable at step 1110 to process the ID to identify the patient or authorized caregiver making the request, e.g., by matching the received ID with information contained in the patient records 304. Thereafter at step 1112, the processor 64 is operable to retrieve the patient's hospital stay information from the database 302, e.g., from the patent records 304. In embodiments in which the patient's hospital stay information is not stored in the database 302, the processor 64 may be operable to request the same from the hospital server 26, e.g., as illustrated in FIGS. 1000-1008 of the process 524 illustrated in FIG. 10. Following step 1112, the processor 64 is operable to retrieve pharmacist information from the database 302, e.g., from the pharmacy consultation data 312. The pharmacist information may illustratively include at least one or any combination of the examples described above with respect to FIG. 3.

Following step 1114, the process 534 advances to step 1116 where the processor 64 is operable to compare the patient's hospital stay information with the pharmacist information and select a number, N, of pharmacists with attributes matching the patient information. As an example of the selection process, the patient information may indicate that the patient underwent joint replacement surgery, and the pharmacist information indicates that of the 24 pharmacists currently on duty, 8 have substantial knowledge of and experience with pain management issues and drug interactions relating to such procedures, and in this example the 8 pharmacists are selected at step 1116. It will be understood that the foregoing example is provided only by way of illustration and is not intended to be limiting in any way. Those skilled in the art will recognize other examples in which the processor 64 may be operable to select one or more pharmacists at step 1116, and it will be understood that such other examples are contemplated by this disclosure.

Following step 1116, the process 534 advances to step 1118 where the processor 64 is operable to control the communication circuitry 72 to transmit a pharmacist communication link to the N pharmacists selected at step 1116. Any such transmission may be to the pharmacist's email address, an application running on a peripheral device accessible by a selected pharmacist, a cell phone of a selected pharmacist, and/or the like. Thereafter at step 1120, the processor 64 is operable to control the communication circuitry 72 to transmit to the MCD 80 a patient communication link, and at step 1222 the communication circuitry 212 of the MCD 80 is operable to receive the transmitted patient communication link and provide the same to the processor 200.

Following step 1122, the processor 200 is operable at step 1124 to control the display 218 to display the patient communication link, and at step 1126 the processor 200 is operable to determine whether the displayed patient communication link has been selected. If not, the process 534 loops back to step 1124, and otherwise the process 534 advances to step 1128 where the processor 200 of the MCD 80 is operable to control the communication circuitry 218 to establish live communication with the first of the N pharmacists to select the transmitted pharmacist communication link. Such communication may illustratively be in the form of a web-based chat interface, a live video exchange, e.g., so-called “facetime,” an email exchange, a live telephone or cell phone link and/or the like.

Following step 1128, and also following the NO branch of step 1104, the process 534 advances to step 1130 where the processor 200 is operable to compare the elapsed time, T, with a time value T_{T}. In one embodiment, the time value T_{T} is determined by the processor 64 of the pharmacy server 60 as a function of one or more components of the patient's hospital stay information. For example, for some hospital stays T_{T} may be one to several hours, for other stays T_{T} may be one to several days, and for still other stays T_{T} may be one to several weeks. In other embodiments, T_{T} may be the same for any hospital stay. In any case, T_{T} is illustratively the amount of time that the patient or authorized caregiver will have access to the pharmacist inquiry process 534. T_{T} may be provided by the pharmacy server 60 to the MCD 80 at any time, and in one illustrative embodiment T_{T} is provided to the MCD 80 as part of the process 520, and/or as part of the process 524 and/or as part of the process 534. In any case, if at step 1130, the processor 200 determines that T<T_{T}, the process 534 loops back to step 1102, and otherwise the process 534 returns to the process 450 illustrated in FIG. 5A.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected. For example, it will be understood that while several process steps in various sequences have been illustrated and described herein with respect to the processes set forth in FIGS. 4-9, any one or more such processes may alternatively include more, fewer and/or different steps, and that any such steps may be executed in different sequences from those illustrated and described, without departing from the scope of the concepts and techniques described herein.

What is claimed is:

1. A system for filling post-discharge medications of a hospital patient, the system comprising:
a retail pharmacy server communicatively coupled to a plurality of affiliated retail pharmacies, the retail pharmacy server including at least one processor,
communication circuitry coupled to the retail pharmacy server, and
a memory having instructions stored therein that are executable by the at least one processor to receive via the communication circuitry a first signal carrying a consent indicator indicating consent by the hospital patient or a caregiver of the hospital patient to fill at least one post-discharge medication prescribed or to be prescribed to the hospital patient, to receive via the communication circuitry a second signal carrying an identifier of one of the plurality of affiliated retail pharmacies at which to fill the at least one post-discharge medication, to transmit with the communication circuitry the consent indicator to a Pharmacy Benefit Management (PBM) service used by a physician of the hospital patient to process the at least one post-discharge medical prescription prescribed thereby in order to gain access to the at least one medical prescription prescribed by the patient's physician, to receive with the communication circuitry the at least one medical prescription from the PBM service based on the consent indicator, and to transmit with the communication circuitry the obtained at least one medical prescription to the identified one of the plurality of affiliated retail pharmacies with instructions to fill the at least one medical prescription.

2. The system of claim 1, wherein the patient is admitted to a hospital, and wherein the identified one of the plurality of affiliated retail pharmacies is co-located at the hospital at which the patient is admitted.

3. A computer implemented method for making a product recommendation to a communication device of a patient following discharge of the patient from a hospital as part of a hospital stay, the method comprising:
causing, with a first processor carried by of a pharmacy server, communication circuitry of the pharmacy server to transmit to a hospital server a request for patient information relating to the patient's hospital stay,
receiving, with the first processor, the requested patient information from the hospital server,
determining, based on the requested patient information, at least one of a product to recommend to the patient, a product to be avoided by the patient and a product to substitute for a product previously or typically purchased by the patient, and
causing, with the first processor, the communication circuitry of the pharmacy server to transmit to the communication device of the patient at least one of the product to recommend to the patient, the product to be avoided by the patient and the product to substitute for a product previously or typically purchased by the patient.

4. The method of claim 3, further comprising:
receiving, with a second processor carried by the communication device of the patient, the transmitted at least one of the product to recommend to the patient, the product to be avoided by the patient and the product to substitute for a product previously or typically purchased by the patient, and
causing, by the second processor, a display carried by the communication device to display thereon the at least one of the product to recommend to the patient, the product to be avoided by the patient and the product to substitute for a product previously or typically purchased by the patient.

5. A computer implemented method for establishing a live communication link between a first communication device of a patient following discharge of the patient from a hospital as part of a hospital stay and a second communication device of one of a plurality of pharmacists of a retail pharmacy, the method comprising:
receiving by a first processor of a pharmacy server a transmitted request for the live communication link and an identification of the patient,
determining, by the first processor, an identity of the patient by matching the received identification of the patient with patient information stored in a database of the pharmacy server,
retrieving, by the first processor from the database, patient information relating to the patient's hospital stay,
retrieving, by the first processor from the database, pharmacist information for the plurality of pharmacists of the retail pharmacy,
selecting one or more of the plurality of pharmacists by matching at least some of the patient information relating to the patient's hospital stay with one or more attributes of the pharmacist information,
transmitting, under control of the first processor, a patient communication link to the first communication device of the patient, and
transmitting, under control of the first processor, a pharmacist communication link to at least one communication device associated with each of the one or more selected pharmacists,
wherein the first communication device and the at least one communication device associated with one of the one or more selected pharmacists establish live communication via the patient communication link and the pharmacist communication link.
